(19) United States
(12) Patent Application Publication
(10) Pub. No.: US 2025/0135664 A1
(43) Pub. Date: May 1, 2025

(54) DEPLOYABLE ROBOTIC SYSTEM

(71) Applicant: Machina Labs, Inc., Chatsworth, CA (US)

(72) Inventors: Kyle Hickey, Moorpark, CA (US); Edward Mehr, Los Angeles, CA (US)

(21) Appl. No.: 18/931,560

(22) Filed: Oct. 30, 2024

Related U.S. Application Data
(60) Provisional application No. 63/594,922, filed on Oct. 31, 2023.

(51) Int. Cl. B25J 18/04; B25J 5/00; B25J 9/16; B25J 13/08

(52) U.S. Cl. CPC B25J 18/04; B25J 5/005; B25J 9/161; B25J 13/085

(57) ABSTRACT

A deployable robotic system includes a set of frames with coupler elements coupled together to form one or more pivot points. The set of frames are configured to (a) fold into a first structure having one or more external dimensions of an intermodal freight shipping container and (b) unfold into a part of a robotic part forming system comprising: a robotic arm with a base coupled to a first frame of the set of frames. The robotic arm includes an actuator system configured to control motion of the robotic arm through space.

### CROSS-REFERENCE TO RELATED APPLICATION

This application claims the benefit of, and priority to, U.S. Provisional Patent Application Ser. No. 63/594,922, “Sheet Part Forming Components and Methods,” filed Oct. 31, 2023, which is incorporated herein by reference in its entirety.

### TECHNICAL FIELD

This disclosure relates generally to robotic systems, and, more particularly, to deployable robotic systems with an unfolded configuration that forms a robotic part forming system and with a folded configuration that forms one or more transportable structures.

### BACKGROUND

### Description of Related Art

Sheet metal parts are used in a multitude of applications and across many different industries (e.g., in aerospace, automotive, biomedical, and consumer electronics industries). Sheet metal part forming is the manufacturing process through which sheet metal parts are made. However, sheet metal part forming is very tool intensive, which makes it costly and time consuming to fabricate sheet metal parts. A method for sheet metal part forming is stamping. In stamping, a series of female and male dies that are specific to each design and material are fabricated (tooling). A sheet metal part is formed in a press machine by sandwiching sheet metal between the two dies with force. Stamping requires a large investment in dies and is not accommodating to changes in design and material, making the sheet metal forming process expensive and time-consuming.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a robotic setup for part forming, according to an embodiment.

FIG. 2A is block diagram of a model, according to an embodiment.

FIG. 2B is a block diagram of a part forming process, according to an embodiment.

FIG. 3 is an image from a simulated part forming process, according to an embodiment.

FIG. 4 is a perspective view of a robotic setup with optical trackers, according to an embodiment.

FIG. 5A is a perspective view of a robot arm with a scanner and load sensor, according to an embodiment.

FIG. 5B is an image generated using scanner data, according to an embodiment.

FIG. 6 includes plots of different forming paths to form a cone, according to an embodiment.

FIGS. 7A-7D illustrate a forming process, according to an embodiment.

FIGS. 8A-8B are perspective views of first and second roller tools, according to some embodiments.

FIG. 9 is a perspective view of a frame holding a sheet, according to an embodiment.

FIG. 10A is a perspective view of a robot arm with a stylus performing a forming operation, according to an embodiment.

FIG. 10B is a perspective view of a robot arm with a trimming performing a trimming operation, according to an embodiment.

FIG. 10C is a perspective view of a robot arm with a hemming performing a hemming operation, according to an embodiment.

FIG. 10D is a perspective view of a tool rack holding a plurality of tools, according to an embodiment.

FIG. 11 is a perspective of a third roller tool, according to an embodiment.

FIG. 12 is a perspective of fourth roller tool, according to an embodiment.

FIG. 13 includes images of two different parts made using a same part design and different forming techniques, according to an embodiment.

FIGS. 14A-14B are block diagrams of other models, according to some embodiments.

FIG. 15 is a block diagram illustrating components of an example machine able to read instructions from a machine-readable medium and execute them in a processor, according to an embodiment.

FIGS. 16A-16E are diagrams of a first example deployable robotic system, according to an embodiment.

FIGS. 17A-17K are diagrams of the first example deployable robotic system unfolding, according to an embodiment.

FIG. 18 is series of side view diagrams of a container of another deployable robotic system, according to an embodiment.

FIGS. 19A-19B are diagrams of another example deployable robotic system, according to an embodiment.

FIG. 20 is a diagram of another example deployable robotic system, according to an embodiment.

FIG. 21 is a diagram of another example deployable robotic system, according to an embodiment.

FIGS. 22A-22F are diagrams of another example deployable robotic system, according to an embodiment.

FIG. 23 is a table of example external dimensions, permissible tolerances, and ratings for intermodal freight shipping containers.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

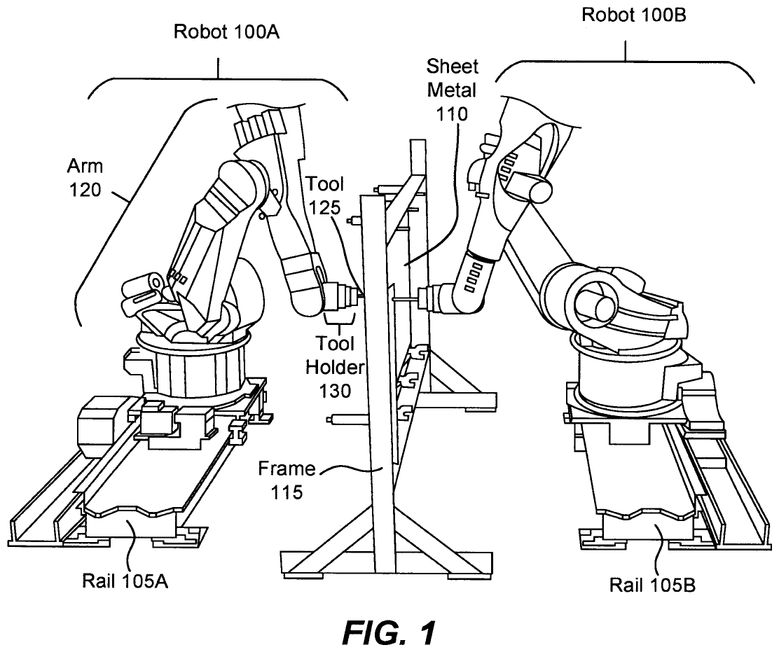

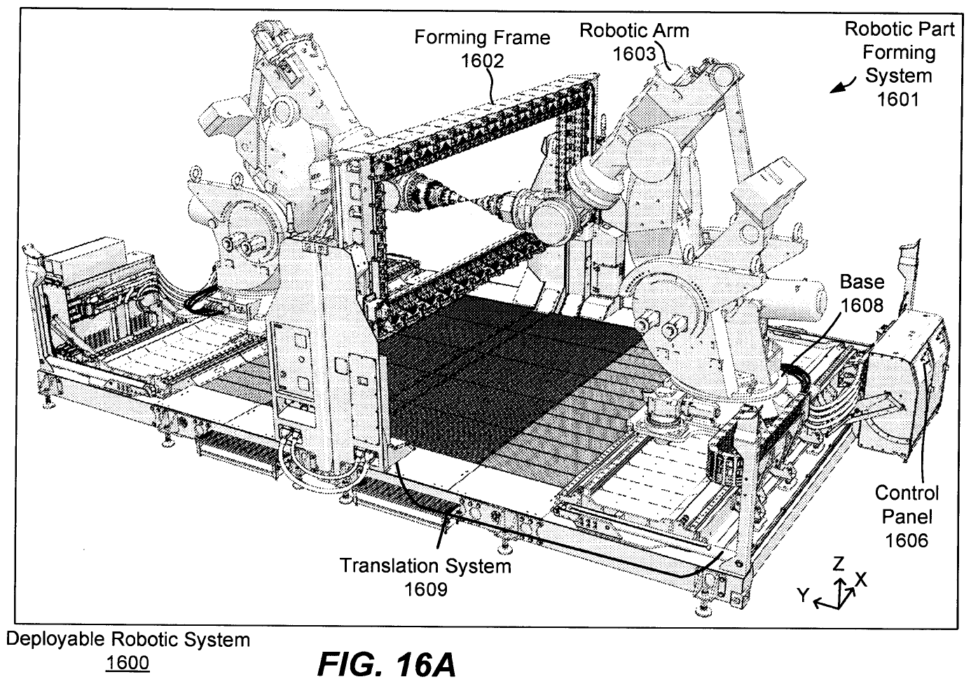

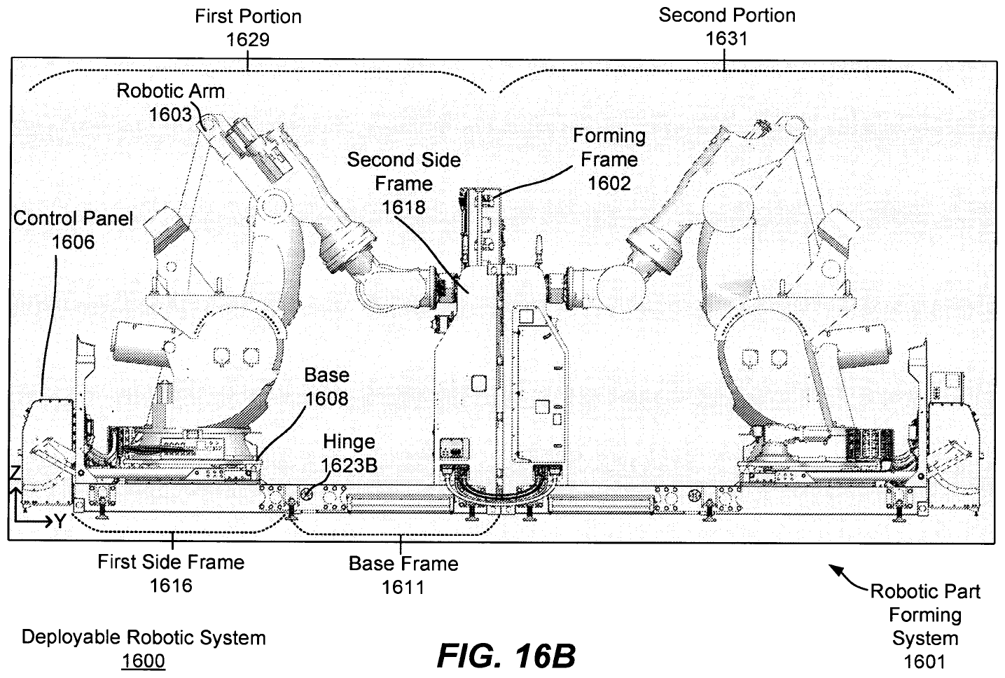

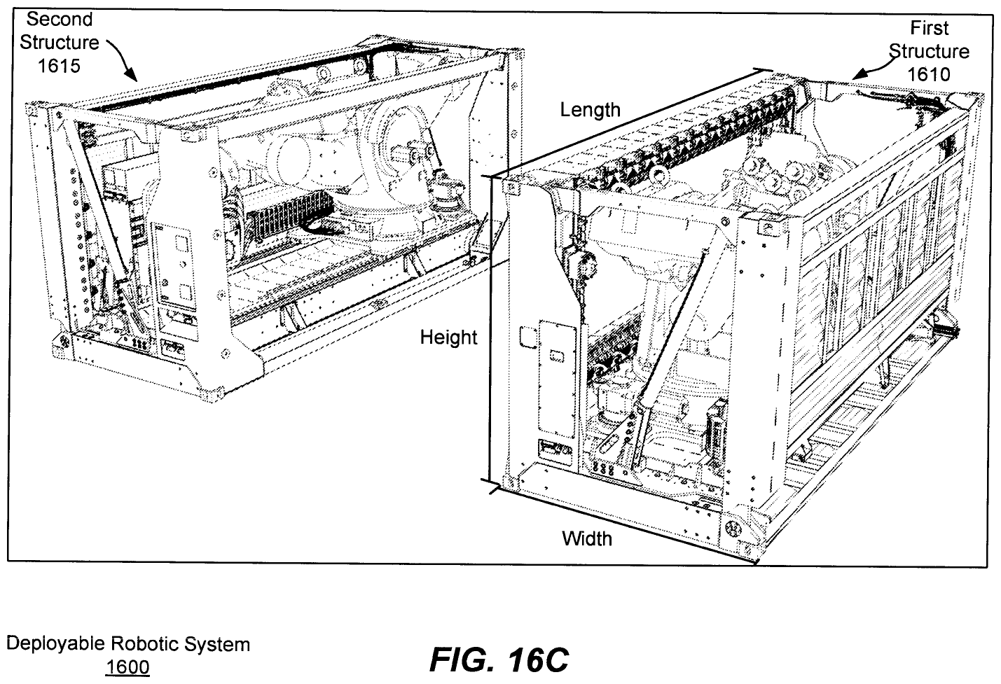

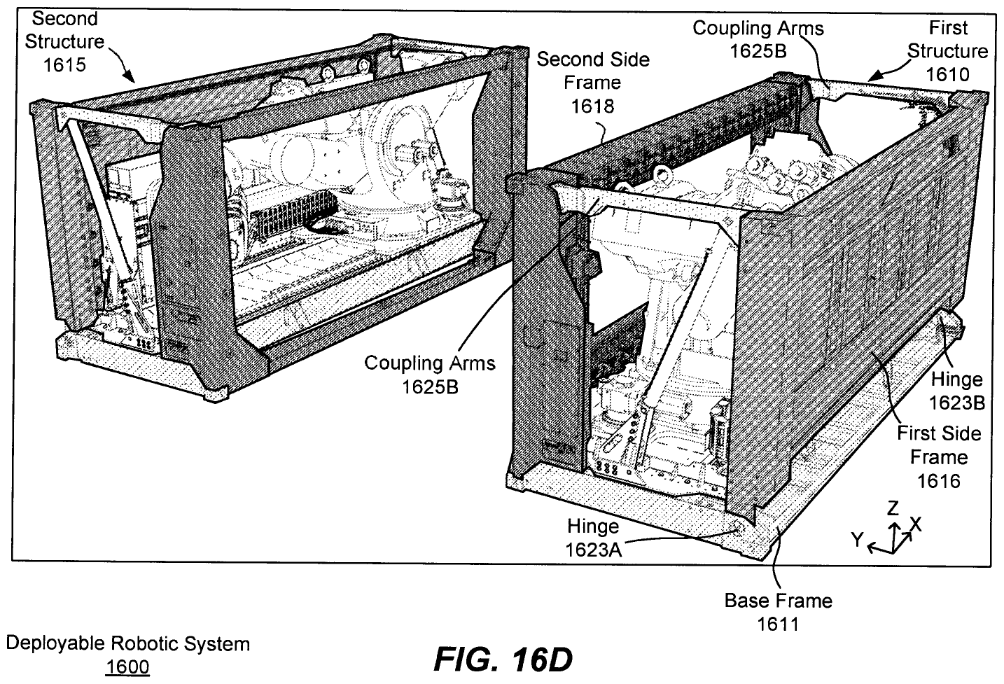

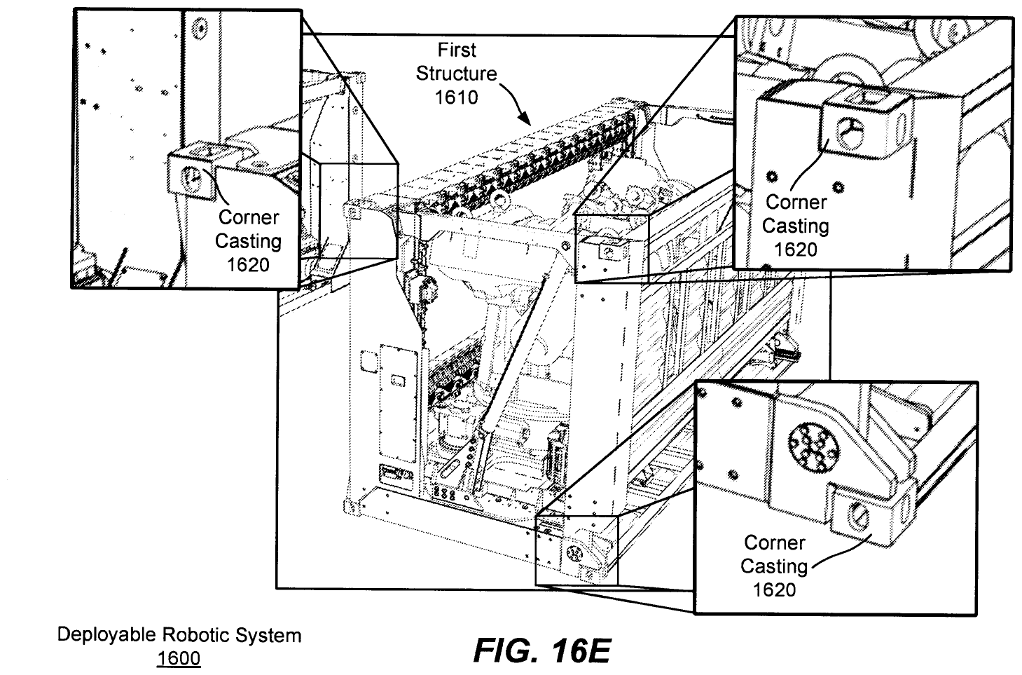

Some embodiments relate to deployable robotic systems, which are in part described below with respect to FIGS. 16A-23. These deployable robotic systems may include or be part of systems for robotic sheet forming, which are described in part with respect to FIGS. 1-15.

In an embodiment a deployable robotic system includes: a set of frames with coupler elements coupled together to form one or more pivot points, the set of frames configured to (a) fold into a first structure having one or more external dimensions of an intermodal freight shipping structure and (b) unfold into a part of a robotic part forming system including: a robotic arm with a base coupled to a first frame of the set of frames, the robotic arm including an actuator system configured to control motion of the robotic arm through space.

### 1. Robotic Sheet Metal Part Forming

Robotic sheet part forming is a sheet metal part forming technique where a sheet is formed into a desired geometry by a series of incremental deformations applied by a robot. For example, the robot is outfitted with a stiff stylus that delivers deformations to the sheet. The robot may change tools to apply different operations (e.g., trimming and hemming) to the metal part. Multiple robots may be used in the process to provide more accurate control of the process.

Increasing the speed and decreasing the cost to manufacture sheet metal parts is desirable for enhancing product development in all stages of design and manufacturing. In light of this, some embodiments relate to an intelligent machine learning-based system that automates object process parameter generation for real-time control of novel robotic forming of sheet metal, plastics, polymers, and composite parts. Relative to conventional techniques, the disclosed (e.g., fast forming) techniques may enable faster prototyping and may enable rapid customization of mass-produced products. Agile production or prototyping in turn enables development of better- quality products and streamlining production. It may also increase industrial competitiveness in both mature and emerging markets by reducing the time and capital used for developing new components. The benefits may extend further for “lightweighting” strategies employed in various industries (e.g., aerospace and automotive) that want to move towards lighter and higher strength alloys but are slowed down by testing of these alloys. For simplicity, the below descriptions refer to forming parts from sheet metal. However, as indicated above, embodiments described herein may be applicable to forming parts from other materials, such as plastics, polymers, and composites.

Robotic sheet metal part forming overcomes the restrictions of the traditional methods by reducing or removing fabrication of tooling and dies from the production process. Robotic sheet part forming is a sheet metal part forming technique where a sheet is formed into a desired geometry by a series of (e.g. small) incremental deformations applied by a robot. For example, the robot is outfitted with a stiff stylus that delivers deformations to the sheet. Multiple robots may be used in the process to provide more accurate control of the deformations.

FIG. 1 illustrates an example embodiment of a setup for robotic sheet metal part forming. Two robots 100A and 100B face each other on respective rails 105A and 105B on opposite sides of the sheet metal 110. The sheet metal is supported by a forming frame 115 (also referred to as a fixture). Specifically, edges of the sheet metal are coupled (e.g., clamped) to the frame to hold the sheet metal in place. The sheet metal is fixed between the two robots to allow easy access from both robots to opposite sides of the sheet. The robots may be high payload industrial robotic arms that can exert forces sufficient to deform the sheet metal (e.g., up to 20,000 N). The amount of force exerted may depend on the material strength and thickness of the sheet. For example, for 2 mm 5xxx aluminum (including aluminum alloys), the peak forces may be 2,000 N. In another example, for high strength martensitic steel, the peak forces may be 20,000 N. The amount of force may also depend on process parameters. For example, there may be a tradeoff between time duration and force (e.g., a 1 mm stainless steel part takes 4 hours to form with a peak force of 4,000 N but it takes 8 hours to form if the peak force is 3,000 N). The robots may comprise an articulated 6-axis robotic arm (e.g., arm 120) capable of moving a tool (e.g., tool 125) (also referred to as an end effector) attached to the end of the arm in a three-dimensional space according to 6 degree of freedom motion. The arm may include an actuator system configured to move the robot in space. For example, each segment of the robot arm includes an actuator to move it relative to another arm segment. The end of the robot arm includes a tool holder (e.g., tool holder 130) that enables one or more selectable types of tools to be attached. The tools can include, for example, a hard stylus having ends of varying diameters, shapes, or materials, a roller tool as described below, a spindle tool, a laser tool, a plasma torch, a cutting tool, or a hole making tool. The robots are also slidable along the rails to enable the robots to operate over a wide range of sheet metal sizes and sizes of the part being fabricated. For example, the part can be as small as a few cubic inches or as big as a few cubic feet (in the volume it occupies). The robot's arms may be controlled by a controller (e.g., an external computation system) that takes into account the geometry of the final part and signals from one or more various sensors installed on the robot. The sensors may include, for example, accelerometers, gyroscopes, pressure sensors, or other sensors for detecting motion, position, and interactions of the robot with the sheet metal.

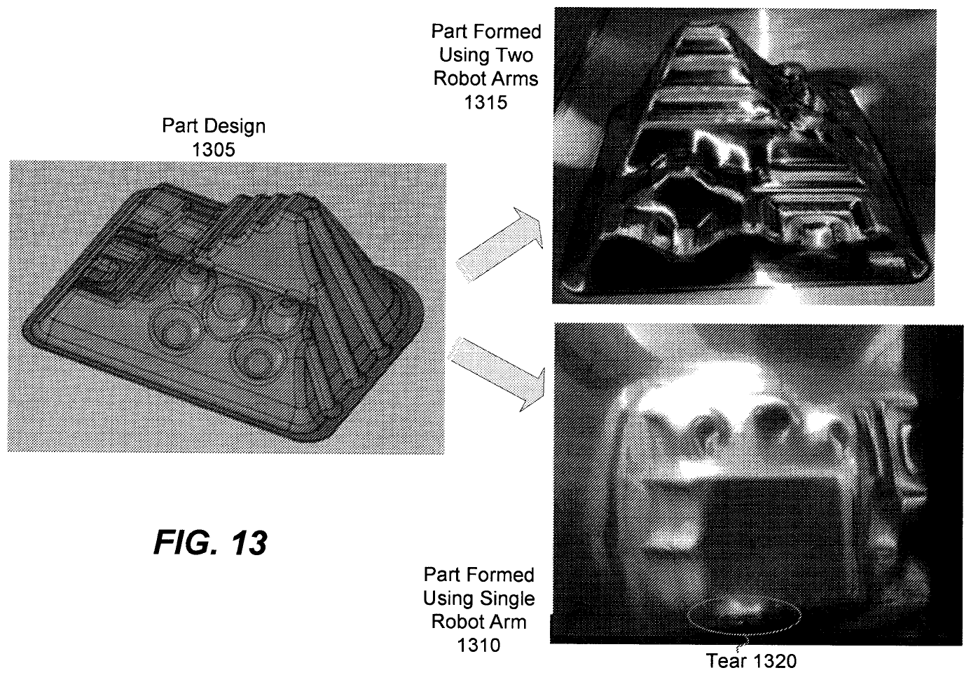

The use of two robots (one on each side of the sheet) may provide several advantages. For example, if only a single robot is used, the sheet may globally deform (instead of locally deform). Thus, using two robots may enable localized deformations. A second robot (also referred to as a support robot) may reduce or prevent tearing of the part by providing supporting pressure on the opposite side of the part. The location of the robots (and their end effectors) with respect to each other may be based on the design of the part and the material and thickness of the sheet. These locations may be determined by a model (described further below). An example of the advantages of two robots is illustrated in FIG. 13. FIG. 13 includes a part design 1305 that illustrates the design of a part to be formed. The images on the right illustrate parts formed based on the design 1305. The bottom right image illustrates a part 1310 formed using only one robot and the top right image illustrates a part 1315 formed using two robots. As illustrated, part 1315 includes more details and more closely resembles the part in 1305. Additionally, the part 1301 includes a tear 1320.

A controller may receive and process sensor data from the sensors to determine the proper parameters (e.g., joint angle values for each joint of the robotic arm) and control the robot arms accordingly. In some embodiments, the robots are controlled to pinch or otherwise apply pressure to the sheet metal with a hard implement (e.g., a stylus) or other tool to form the sheet of metal in accordance with a program applied by the controller to result in a desired geometry. For example, the program controls the robot arms to move in a particular sequence and apply the tool to the sheet metal according to particular programmed parameters at each step (e.g., time step) of the sequence to achieve a programmed geometry. The program (via the robotic arms) may cause the different applied tools to bend, pinch, cut, heat, seam, or otherwise form the metal in accordance with the program.

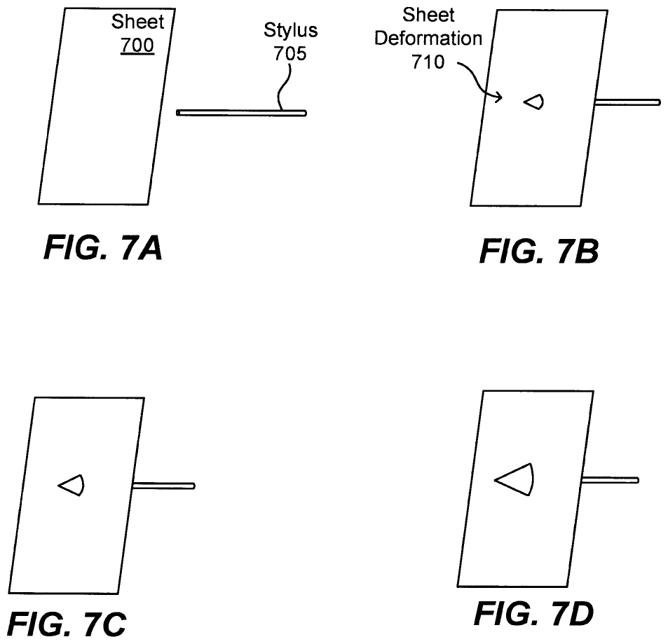

An example part forming process is illustrated in FIGS. 7A-7D. The FIGS. include a sheet 700 and a stylus 705 (e.g., coupled to a robot arm). In FIG. 7B the stylus is applied to the sheet. The result is a deformation 710. FIGS. 7C and 7D illustrate larger deformations that result from the stylus being applied to different locations on the sheet (e.g., in a spiral pattern). To facilitate the deformation into a desired geometry (e.g., a cone), a second tool (e.g., coupled to a second robot arm) may be applied to the opposite surface of the sheet.

### 2. Controller and Model

The controller determines the process parameters to achieve the desired robotic forming operations. Parameters such as the path of the robotic forming tool during the process, its speed, geometry of the forming tool, amount of force, angle and direction of the forming tool, clamping forces of the sheet, etc. may have direct but nonlinear effects on the final geometry. The part forming process may include a set of time steps, where each step describes parameters values for one or more parameters. The part forming process may be iterative. Thus, by executing the system according to the parameter values at each time step, the controller may form the part described in the input design. The parameters values may be determined by the model.

The disclosed robotic system may achieve real-time adaptive control of a part forming process. The method may start with an input design of a part and a (e.g., statistical) model that is generated using a training data set. The training data set may include data from simulation data, and physical process characterization data (such as an in-process inspection or post-build inspection from previously formed parts or geometries). An in-process inspection may include inspecting a part during the forming process. For example, a scanning sensor records the shape of the part as it is being formed. In another example, an eddy current sensor detects defects like cracks. In another example, a force sensor measures the forces applied to the part. A post-build inspection is intended to gather information on a fully formed part. A post-build inspection may include similar inspection techniques as an in-process inspection (e.g., inspecting a part using a scanning sensor or eddy current sensor). However, a post-build inspection may include inspection techniques not performed while the part is being formed (e.g., due to practicality). For example, a fully formed part may be inspected using an x-ray machine.

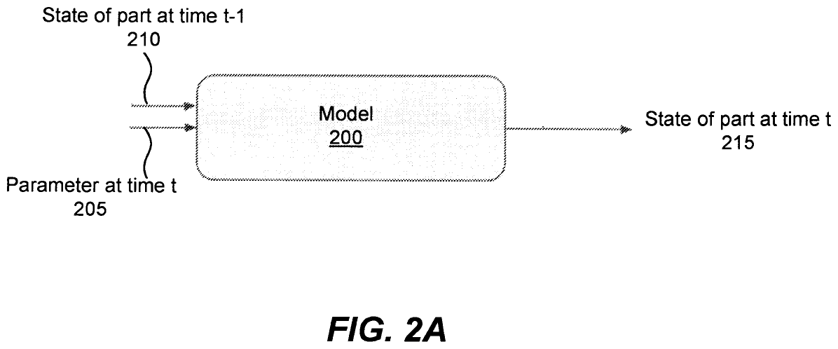

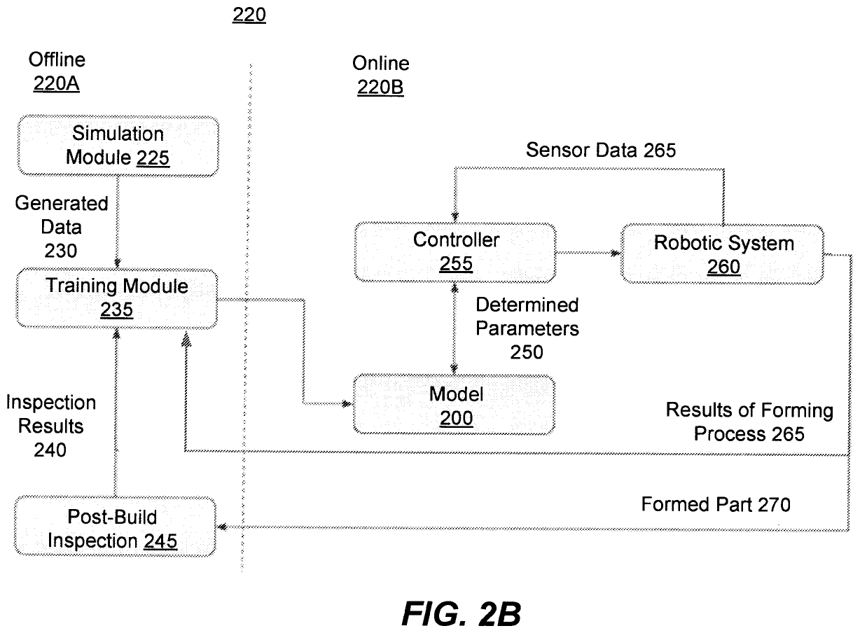

FIG. 2A is a block diagram of an example model 200. As indicated above, the model may be a machine learned statistical model. The model receives one or more parameters 205 to be applied at time step t and the state 210 of the part at time step t-1. The state may refer to the geometry of the part. The model outputs the state 215 of the part at time step t. Thus, for a given state, the model can predict how the part will respond to the application of various parameters. More generally, the model may be used to predict how a material will deform when it goes through a programmed forming process (e.g., over multiple time steps)

A state of the part may be described by a mesh. The mesh may be a graph of coupled nodes, where each node represents a physical point of the part metal. Each node may be described by the following variables: X, Y, Z, F1z, F1x, F1y, F2z, F2x, F2y, thickness, dx, dy, and dz. X, Y, and Z represent the location of the node in space. Thickness indicates the sheet thickness at that node. Each node may be coupled to neighboring nodes (e.g., three neighbors). These coupled nodes represent the part in cartesian space. F1z, F1x, and F1y represent the force that one of the robots (e.g., robot 1) is applying at that node, and F2z, F2x, F2y represent the force another robot (e.g., robot 2) is applying at that node. dx, dy, and dz represent the size of movements capable at a node if the robots pull back from the part at this time (e.g., they capture the elastic strain of the material).

The model can be used to determine the process parameters (e.g., in real time or offline). This method automates the generation of parameters for the robotic forming process (further described in the next paragraph). Due to the optimization process, the generated parameters may not be conceivable by engineers.

After the model is determined (e.g., by a training process), optimization techniques may be used to determine parameters to apply at each (e.g., time) step of the part forming process to create the intended part geometry. For example, for a given time step, the model is applied to various input parameter values according to an optimization technique to determine which parameter values will result in a desired geometry (or a geometry close to the desired geometry). Multiple optimization techniques may be used. Example optimization techniques include gradient descent, Adam optimization, and Bayesian optimization. An optimization technique may be chosen based on the complexity of the desired geometry. The optimization may be done both in the long and short horizons (e.g., time scales). The long horizon optimization may be done offline (before the part forming process begins) to determine steps of the process (e.g., step by step instructions for the robot to achieve the desired geometry). For example, a long horizon optimization may determine how to form a material sheet into a fully formed part. In some embodiments, long horizon optimizations determine a set of intermediate geometries that occur during a part forming process (e.g., intermediate geometries between the sheet and the fully formed part (e.g., for each time step or layer)). However, errors or inaccuracies may accrue over time (e.g., for processes with lengthy build times or processes with a large number of time steps). For example, the part may deform differently than the model predicted. To remedy this issue, short horizon optimizations may be performed during the forming process (online) to reduce or correct errors that may accrue. For example, the model is queried by a (e.g., online) controller that can modify (e.g., correct) steps determined during the long horizon optimization based on the current state of the sheet. For example, for a given time step, instead of assuming the part has a geometry predicted by the long horizon optimization, sensor data may be used to determine the actual geometry of the part. The model may then be queried to determine a new set of parameter values for the time step (or modify the long horizon parameters associated with the time step). For example, the model may be queried to determine which parameter values will form the actual geometry into the predicted geometry (or another intermediate geometry from the long horizon optimization).

While long horizon optimizations may be used to determine an entire part forming process or significant portions of the process, determinations made by short horizon optimizations may be limited to small portions of the part forming process. For example, a short horizon optimization determines a number of interactions (e.g., less than ten) between the end effector and the part. In another example, a short horizon optimization determines interactions between the end effector and the part that will occur during a time window (e.g., less than ten seconds). In another example, a short horizon optimization determines parameter values for a set of time steps (e.g., less than ten time steps). In another example, a short horizon optimization determines how to form a part in a first geometry into a second geometry, where the first and second geometries are intermediate geometries determined by a long horizon optimization. In another example, a short horizon optimization is used to determine how to form a part so that it is a threshold percent closer to a final geometry (e.g., less than ten percent).

In some embodiments, a long horizon optimization is used without short horizon optimizations (e.g., the model has a threshold accuracy or the part forming process has a short build time or a small number of time steps). In some embodiments, short horizon optimizations are used without a long horizon optimization.

Referring back to the model 200, the model may be trained using the data from a simulation module. Additionally, or alternatively, the model 200 may be trained using data (e.g., sensor data) from a physical process that forms a part.

In some embodiments, multiple models are trained. For example, models may be trained using different machine learning techniques. Additionally, or alternatively, models may be trained for specific materials (e.g., steel vs. aluminum), geometries (simple vs. complex), or sheet thickness (e.g., 1 mm vs. 2 mm). Among other advantages, models trained for specific specifications may be more accurate than a general model.

FIG. 2B is a block diagram illustrating an example of the process 220. The process includes an offline learning process 220A and online process 220B. In this context, “online” refers to a time period when a part forming process is occurring (e.g., a robot is deforming a metal sheet to form a part), and “offline” refers to a time before or after a part forming process. The offline process uses simulation data 230, data 265 generated by an in-process inspection, and data 240 generated by a post-build inspection (of the formed part 270) to train model 200. Example data from an in-process inspection is metrology data. Example data post-build inspections includes geometry scans or X-rays of the finished part. After the model 200 is generated, it may be used to determine a part forming process.

The model 200 may also be applied by the controller 255 of the robotic system 260 in the online process. More specifically, the model 200 may determine predictions about the resulting change in geometry from each parameter change at each point in time in the part forming process. In the online process, the controller uses sensors installed on the robotic forming system to obtain sensor data 265 to determine a current geometry of the part. The current geometry may then be input to the model 200. The model predicts the outcome (e.g., a resulting change in geometry) of changes in those process parameters. By iterating over different possible parameters and their outcome predicted by the model, the controller identifies and chooses the (e.g., best) parameter 250 that produces the most desirable outcome to control the robotic forming system through a forming process that achieves the desired geometry. The controller uses the best parameters and may repeats this optimization cycle (e.g., in every step of the process) to improve the outcome.

In addition to the model 200 described above with respect to FIG. 2A, other models are possible. Two examples are provided below.

### 2.1 Blackbox Model

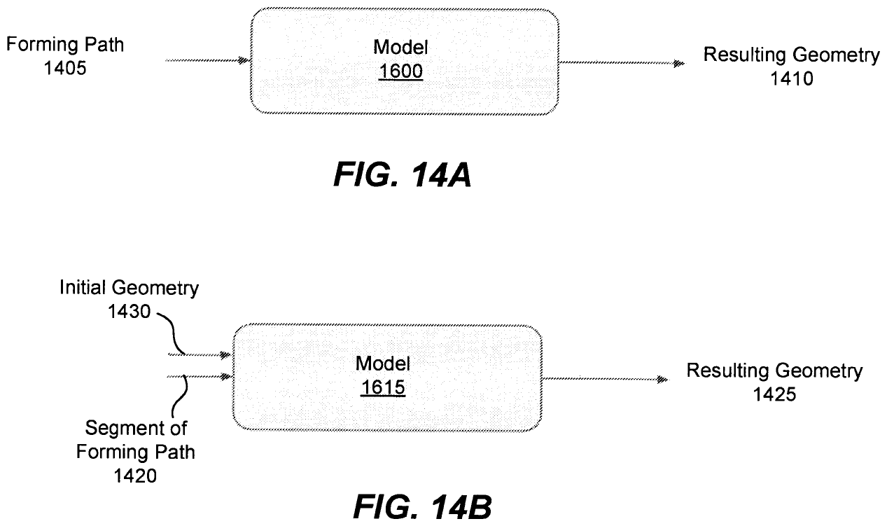

FIG. 14A illustrates an example black box model 1400. The model receives an entire forming path 1405 to be applied to a material sheet and outputs the resulting final geometry 1410 formed by the path. Thus, the model may be trained using data that describes various forming paths and the resulting part geometries. Since the model is not trained to account for physical phenomena (e.g., elastic deformation, global deformation, buckling) the model may be trained using large amounts of training data.

A more complex model is the one that breaks the forming process into layers and tries to predict the effect of various parameter values at each layer. In this context, “layer” refers to a section of a part. For example, a first layer refers to the section that extends one inch away from the original sheet and a second layer refers to the section that extends from the first inch to the second inch. An example of a layer based model is further described below.

### 2.2 Layer Based Model

FIG. 14B illustrates an example layer based model 1415. For input, the model receives a segment of a forming path 1420 and the initial geometry 1430 of a metal part (e.g., a sheet or other geometry). The segment of the forming path 1420 may include enough forming path to form a new layer of the part. The model outputs a resulting geometry 1425 (e.g., the geometry of the part with a new layer). Training data for this model may be generated by determining a forming path (e.g., set of parameter values) that formed a new layer of a part (e.g., scan every layer or every few layers).

Model 1415 may be developed as a sequence model which means it may be any of the sequence architectures (e.g., RNN, LSTM, Transformers). This model has more advantages than model 1400 since it is agnostic to general changes to the policy for forming robots. For example, model 1415 may be used to model inset adding or doing ADSIF or grouped DSIF. That being said, in some embodiments, model 1415 does not capture physical phenomena that may occur during each layer or group of layers.

### 3. Simulation

Referring back to FIG. 2B, the simulation module 225 simulates interaction of a robot-controlled tool, such as a stylus, with a sheet metal or other material. In one example, the simulation may be done using a finite element method. The simulation may be performed to generate simulation data indicating various input parameter values and resulting part geometries. The simulation may be replicated (e.g., in computer data centers) to generate large amounts of simulation data 230. The simulation speed and rate of data generation can be significantly enhanced using GPUs. The large amounts of data may be beneficial for training the model (e.g., instead of only relying on data generated from using a robot arm to physically deform a sheet).

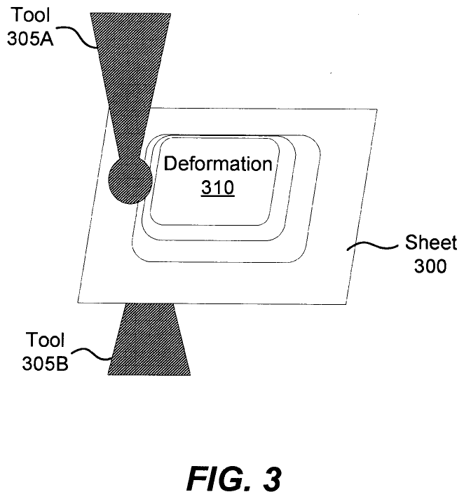

FIG. 3 illustrates an example image from a simulation. The image includes a three-dimensional simulation of a sheet 300 and two tools 305A and 305B interacting with the sheet. The tools may be coupled to robot arms. Tool 305A is interacting with the top surface of the sheet, and tool 305B (partially blocked by the sheet) is interacting with the bottom surface of the sheet. The tools are pressing into the sheet to form a deformation 310. In the example of FIG. 3, the deformation is a rectangular hill protruding upward.

Referring back to FIG. 2B, input for the simulation module 225 may be a specification for a sheet, such as its material properties (e.g., the stress-strain curve) and failure criteria (e.g., mechanical failure of the sheet). Failure criteria may be one or more rules that specify when a part has torn or cracked. The criteria may be based on thickness of the sheet, the material properties, and the amount strain put into the sheet. The simulation module may also receive a specification for one or more programmed forming paths (e.g., determined heuristically) and the type and size of the end effector (e.g., stylus). The simulation module outputs, for a sequence of time steps of the programmed control process, the resulting formed geometry.

By varying different input process parameters such as the forming path, its speed, and the geometry being formed, the simulation module 225 can generate a (e.g., large) data set indicating how a specific metal is deformed with this process (e.g., how metal deforms in response to certain input parameters). The simulation data is used to train a model (e.g., by a training module). The model may be trained using one or more different machine learning techniques and constructs, such as Neural Networks, Random Forests, Decision trees, or regressions. in some embodiments, the training techniques are supervised learning techniques.

In some embodiments, the simulation data is used to train an initial model. The initial model may then be refined or retrained using data from physical part forming processes to increase the accuracy of the model.

In the examples described above, the model is generally described in the context of forming operations. However, the model (or another model) may be trained to predict other part operations, such as trimming or hemming.

### 4. Instrumentation of Robotic Part Forming

The model created using simulation data may be further trained from data derived from an actual physical process that uses a robot arm and an actual sheet. The physical system is equipped with one or more different types of sensors. Example sensors include: (1) encoders in the robot joints that provide positional information as determined by the position of the joints, (2) optical trackers (e.g., a camera) that track the location of robot in (e.g., 3D) space, (3) surface scanners to generate as-built geometry of the part before, during, and after the forming process (surface scanners may have a point accuracy of 0.5 mm), (4) load sensors that determine the force the forming end effectors apply on the sheet, (5) ultrasonic sensors (e.g., electromagnetic acoustic transducer or EMAT) for real-time monitoring of material thickness, and (6) eddy current sensors (e.g., pulsed eddy current) for real-time monitoring of the metallurgical state of metallic sheet. In some embodiments, if the surface scanner is attached to the robot arm, surface scanner data may be stitched together based on the encoder data to determine the geometry of a part (the location of the scanner depends on the position of the arm).

The encoders may be attached to each joint on the robot to track its actual movement, the optical trackers may be mounted around the manufacturing cell. This allows the optical trackers to capture images that include tracking targets installed on the robotic arms and the frame holding the sheet in place. The load sensor and scanner may be attached to the end-of-arm tooling to track forming forces and deformation of the sheet during the process.

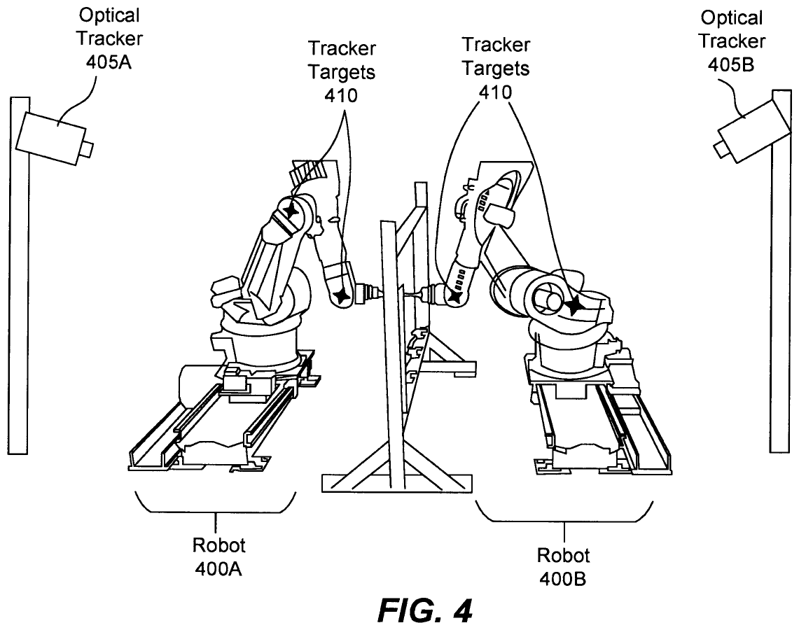

Example optical trackers are illustrated in FIG. 4. FIG. 4 includes two robots 400A and 400B in a manufacturing cell. FIG. 4 also includes two optical trackers 405A and 405B. The robots include tracker targets 410 located at various points on the robots. The optical trackers capture images of the robots and identify the locations of the tracker targets in the images. Thus, the locations of the robots in space can be determined. Although not illustrated, the sheet metal or frame may also include tracking targets to track locations of the robots relative to the metal sheet or frame.

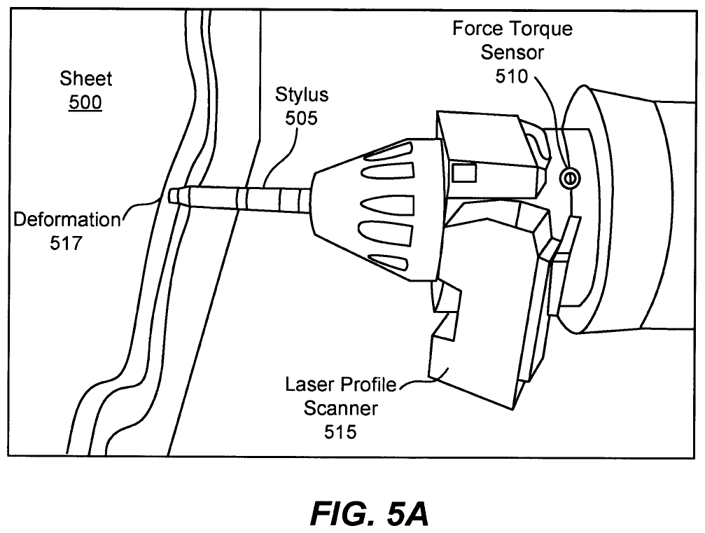

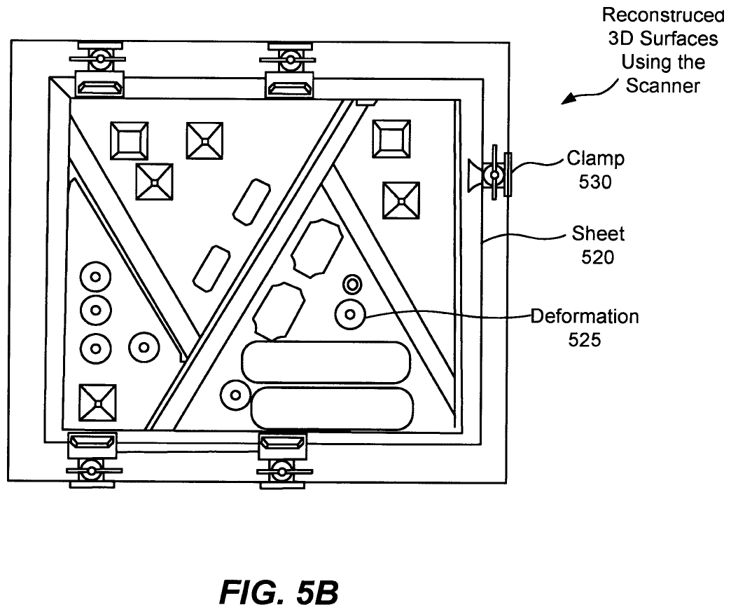

In some embodiments, the robot arm is outfitted with a scanner and a load sensor (e.g., force/torque sensor) as illustrated in FIG. 5A. FIG. 5A illustrates a zoomed in view of an end of a robot arm. The robot arm interacts with a metal sheet 500 via a stylus 505 to create a deformation 517. The arm also includes a force torque sensor 510 and a laser profile scanner 515. FIG. 5B is an example image generated using data from the laser profile scanner 515. FIG. 5B illustrates a reconstructed three-dimensional surface of the metal sheet. The image includes clamps 530, a sheet 520, and deformations 525 in the sheet.

With the sensors described above, accurate data can be captured to characterize steps of a part forming process.

Referring back to FIG. 2B, the training module 235 obtains data 230 generated by the simulation module 225 (e.g., parameters and estimated final geometry of a part for a given forming process), sensor data 265 generated during a part forming process, and data 240 generated during a post-build inspection 245 (e.g., actual final geometry of the part). The training module 235 trains a machine-learned model 200 that maps input parameters to a resulting geometry.

### 5. Using The Model in Control Loop

Once a process model 200 is generated using the above-described training process, the model may be applied in the control process of the robotic forming in two ways. The model may as an input takes a specification for a sheet, such as its material properties (e.g., stress-strain curve) and failure criteria. It may also receive a specification for forming paths (which may initially be determined offline) and the type and size of the tool. The model can be either queried online for optimized process parameters for each time step of the process in real-time, or it can be used in the design of experiments offline to determine optimal policy for forming the part. The policy here refers to general pathing strategies in forming a part.

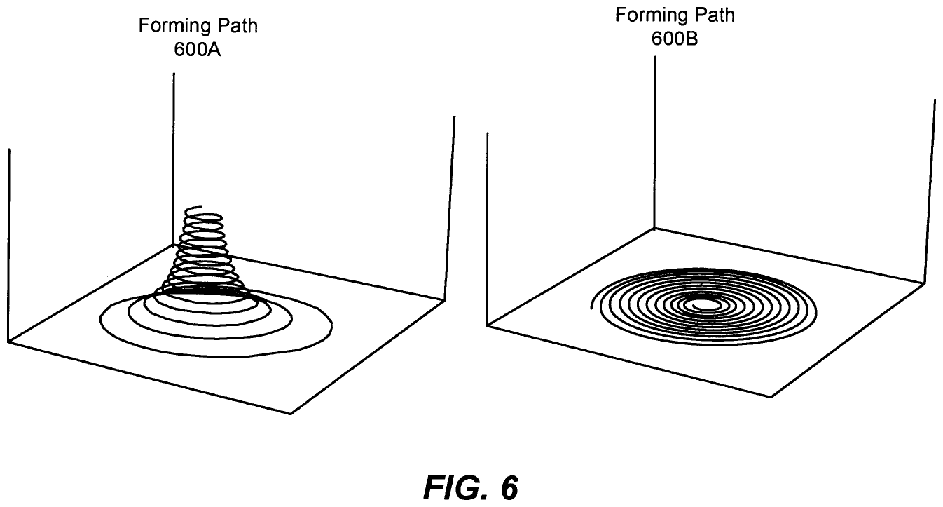

FIG. 6 illustrates two different strategies for forming a cone in an example forming process. Both can be evaluated (e.g., by the controller 255) using the machine-learned model 200 to determine a preferred path. The model can also be used (e.g., by the controller 255) to determine a combination of strategies for different locations in the part that might yield the best outcome. On the left side of FIG. 6 is a depiction of a forming path 600A that starts the forming from outside and moves in a circular pattern toward the inside of a cone (first forming the largest radius and then moving toward forming a smaller radii). On the right side of FIG. 6 is depiction of a forming path 600B that starts forming from inside and moves in a circular pattern toward the outside of a cone (first forming the tip of the cone with the smallest radius and then progressively forming larger and larger radii). The model can be used predict the outcome of both strategies to determine the best strategy or their combination for different parts.

Two categories of systems discussed below may increase the speed of sheet metal part fabrication using robots. The first system and design (“Forming With Rollers”) increases the speed of the forming process itself, while the second (“Integration of Downstream Processes”) addresses downstream processes from part forming to decrease total fabrication time.

6. Forming with Rollers

To increase the speed of the part forming process, an end-effector tool may be configured to interact with the sheet metal with reduced (e.g., low) friction forces. Reducing friction allows for reduction in vibrations in the sheet and hence allows increased speed of forming without negative impact on the geometrical accuracy of the formed part. It may also result in better surface quality (e.g., reduced tearing and galling) compared to tools not configured to reduce friction (e.g., static forming tools).

An example tool configured to reduce friction is a stylus made of a material (or coated with a material) configured to reduce friction. Thus, if the stylus is dragged across the surface of a part, the reduced friction may reduce or eliminate surface degradations and increase the path speed.

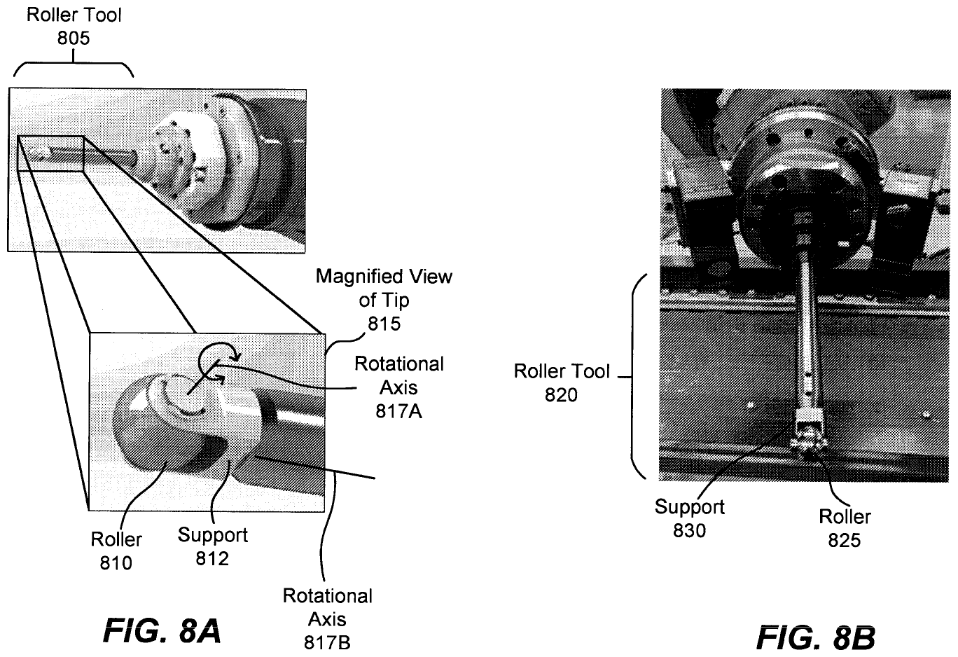

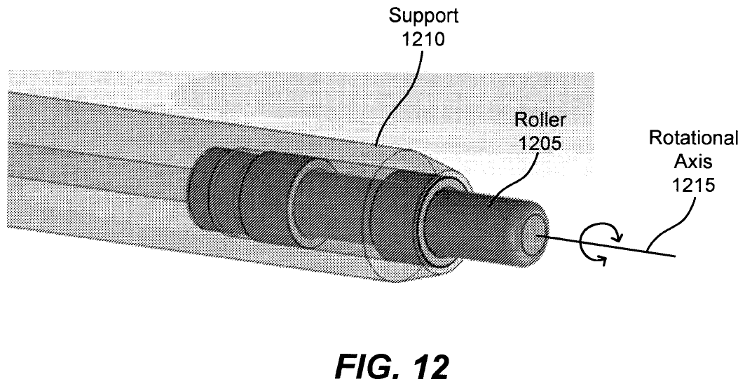

Other tools configured to reduce friction may include roller tools. Roller tools may result in lower friction forces than a stylus. Different rollers with different radii and shape can be used to accommodate for different features in the part design. FIGS. 8A-8B illustrate example embodiments of roller tools. FIG. 8A includes an image of a roller tool 805 coupled to a robot arm and a magnified view of the tip of the roller tool 815. The tip of the roller tool includes a roller 810 held in place by a support 812. The support allows the roller to rotate about an axis 817. FIG. 8B is an image of a larger roller tool 820. Similar to FIG. 8A, tool 820 has a roller 825 and a support 830. Another example of a single axis roller is illustrated in FIG. 12. The tool includes a roller 1205 with a support 1210. The roller can rotate about axis 1215, which is parallel to a long axis of the support.

In some embodiments, the roller can only roller about a single rotational axis (e.g., as in FIGS. 8A and 8B). However, the robotic system is controlled, via the controller, to orient the roller tool so that the roller rolls along the desired direction of movement (the desired direction of movement may be set by the program). Said differently, the roller tool may be oriented so that the rotational axis of the roller is perpendicular to the direction of movement of the roller tool. The illustrated rollers are specifically suitable for part forming with articulated 6-axis robots, since the robots can take advantage of the 6 degrees of freedom to align a roller in the direction of the movement during part forming. The roller may be held with the same mechanism as the stylus or other tools using a tool holder that is mounted at the end of the robotic arm.

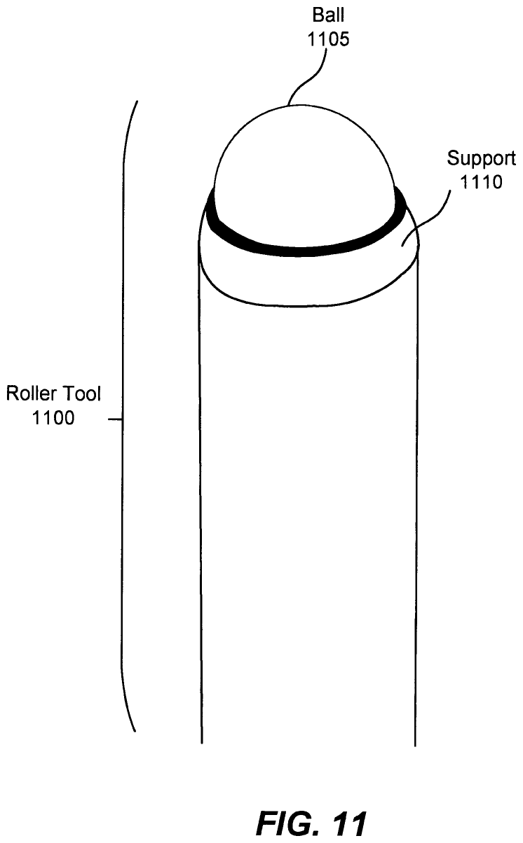

In some embodiments, a roller tool includes a roller that can rotate about multiple rotational axes. An example, of this is illustrated in FIG. 11. FIG. 11 includes a roller tool 1100. The tool 1100 includes a ball 1105 in a socket that may be part of a support 1110 for the ball. The ball can rotate in the socket. Thus, the tool can move in different directions along a part surface without the robot rotating the support along the long axis. Due to the socket configuration, the roller tool 1100 have less friction than a stylus but more friction than a single axis roller (e.g., as illustrated in FIGS. 8A and 8B).

The disclosed roller design installed on a robotic setup allows for robotic part forming with reduceds friction, hence reduced forces which then allows for better surface quality of the formed part and increased speed of the forming process.

### 7. Integration of Downstream Processes in the Forming Setup

Sheet metal part forming may be one of many manufacturing steps performed to produce a final sheet metal part. For example, a sheet metal part also goes through trimming, hole making, hemming, or other processing steps after the part forming process. Traditional methods involve transferring a sheet metal part from one specialized manufacturing station to another, performing each manufacturing step in each corresponding station to produce the delivering the final part. This results in increased manufacturing time due to the time for physically moving the part from one station to another.

Each of the downstream processes generally has its own specific tooling. For example, for trimming a part, it is desirable to use a geometry specific frame that can hold the geometry of the part while a trimming operation is performed.

In some embodiments, the robotic system allows for performing two or more (e.g., all) downstream manufacturing steps in the same station using the same robotic setup, thus avoiding moving of the part and decreasing the total fabrication time. Each downstream process may use a different tool. For example, when performing trimming (e.g., hole making), the robot arm may attach different tools such as a spindle, laser, or a plasma torch. The robotic arm can be controlled to automatically change the tool through software instructions of the program executed by the controller (e.g., controller 255). For example, the controller can control the robot arm at varying times throughout the process to perform a programmed operation on the sheet metal with a particular tool, to control an actuator to release a tool from the tool holder (e.g., into a tool rack), and to cause the robot arm to attach a new tool from the tool holder (e.g., from the tool rack) for performing a subsequent operation.

In some embodiments, the steps that enable automatic integration of downstream processes in the same station may include the following. (1) the robot goes to a tool rack and picks up a forming tool (e.g., a stylus) using predefined software instructions sent to the robot. (2) the robot forms a part from a flat sheet of metal through software defined path and parameters. (3) After the part is formed, the robot moves back to the tool rack, disengages (e.g., drops) the forming tool, and picks up a trimming tool. This step may also be automated with software instructions. (4) The robot performs a trimming operation on the part with the trimming tool. If further downstream processes, such as hemming (e.g., bending), are used to finish the part, the system may continue from step 3 until no more processes are left to perform. If a station includes multiple robots, the robots may work in conjunction using the same or different tools to achieve a desired process (e.g., a forming or trimming process).

If a manufacturing area includes multiple cells (e.g., each including two robot arms), instead of each cell changing tools to perform different operations, each cell may be assigned to a specific operation. In these embodiments, a part may be moved from one cell to another after each operation on the part is complete.

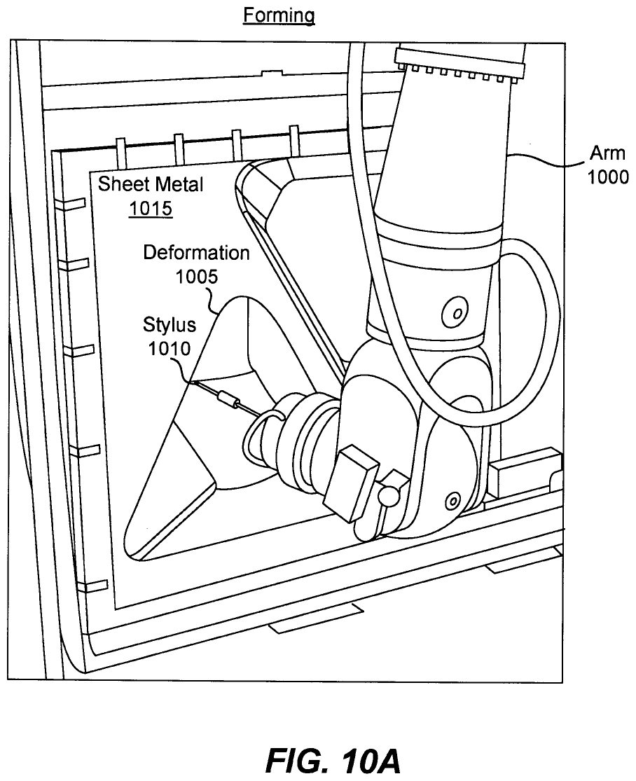

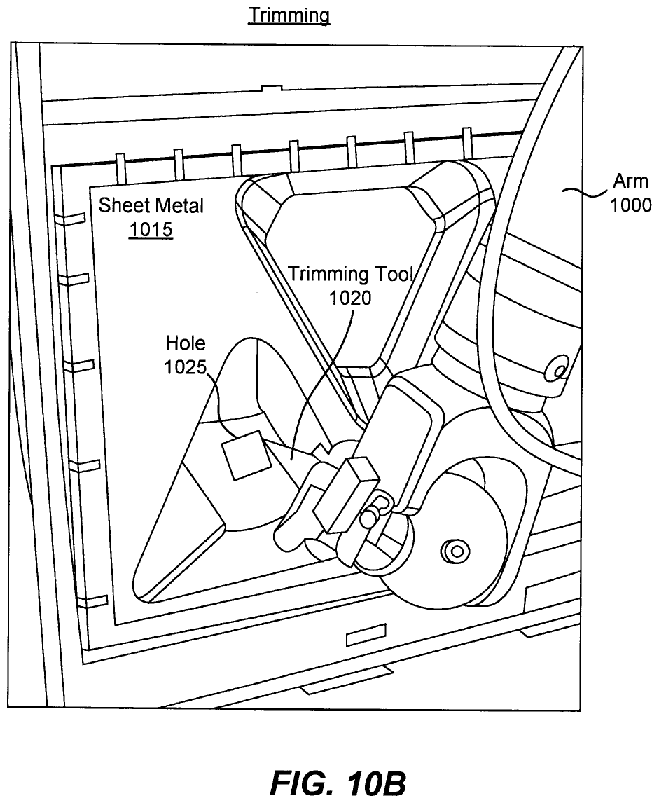

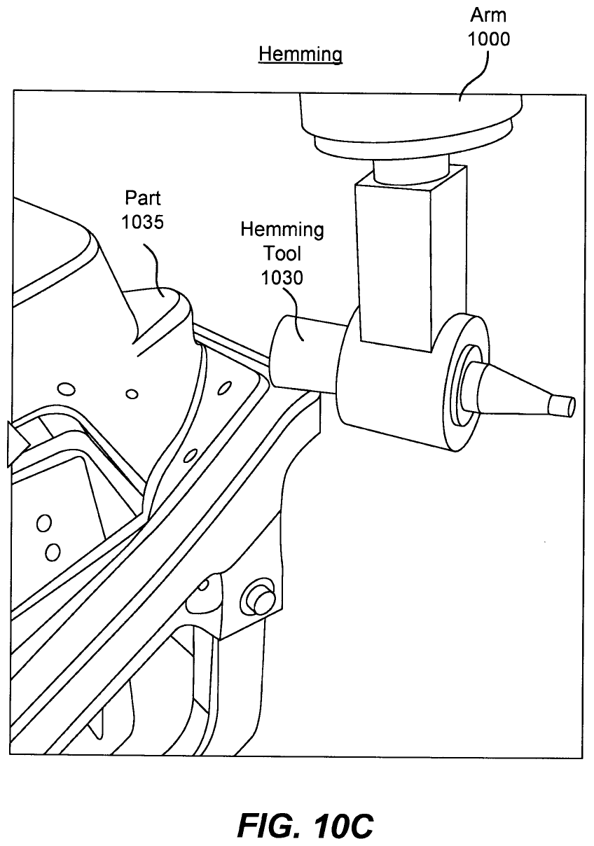

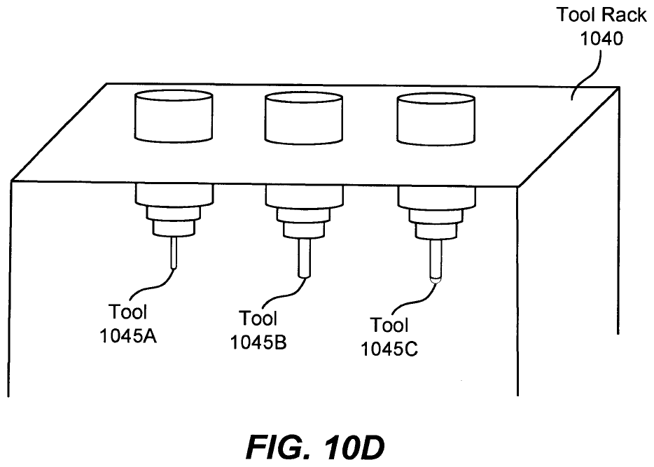

FIG. 10 includes images of various manufacturing processes described above. FIG. 10A illustrates a robot arm 1000 forming a deformation 1005 by pressing a stylus 1010 against a piece of sheet metal 1015. FIG. 10B illustrates the robot arm 1000 with a trimming tool 1020. The trimming tool is used to cut a hole 1025 in a portion of the deformation. To determine the location of the hole, a controller of the arm (e.g., controller 255) may compare a design of the deformation (e.g., in a computer-aided design file) with the current geometry of the deformation (the current geometry may be determined from sensor data). For example, after the deformation is formed, the robot picks up a scanner sensor, scans the deformation and, based on a design of the deformation, determines the path to trim the deformation. After that, the robot may pick up a trimming tool. FIG. 10C illustrates the robot arm 1000 with a hemming tool 1030. The hemming tool is used to bend a corner of a part 1035. FIG. 10D is a perspective view of a tool rack 1040 holding a plurality of tools 1045. The rack may be placed near a robot arm (e.g., arm 1000) so that the arm can exchange tools. In the example of FIG. 10D, tools 1045A and 1045B are styli and tool 1045C is a roller tool.

### 8. Frame

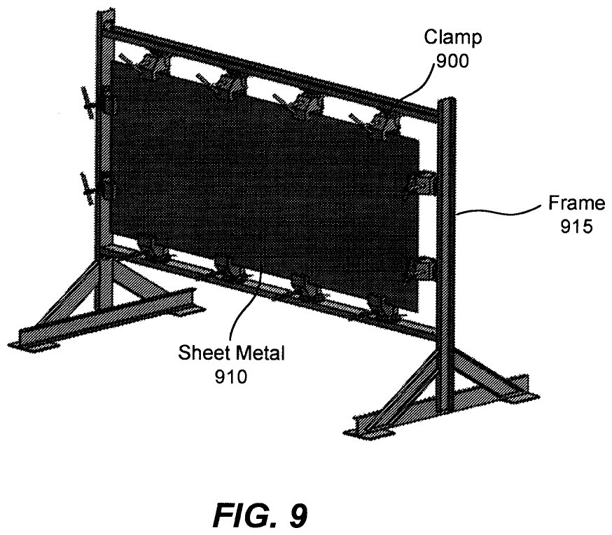

FIG. 9 is a perspective view of a forming frame 915 (also referred to as a fixture), according to an embodiment. In the example of FIG. 9, the forming frame 915 includes a series of clamps 900 that hold the sheet metal 910 in place. Specifically, the frame surrounds the edges of the sheet metal and the clamps are clamped to edge portions of the sheet metal 910. The clamps may be hydraulic or electric (e.g., servo). The clamps may be electronically operated. The frame and clamps may be sturdy enough to hold the sheet metal in place as the robot arms apply different processes (e.g., deformation forces) to the sheet. The frame enables access to large sections of the sheet metal 910 with robotic arms. Thus, it may eliminate the need for any method-specific modification in the fixture that is traditionally required with downstream operation from sheet forming.

Thus, the stand design and software-controlled tool changer for controlling the robotic arms allows for automated downstream operations from forming of the sheet metal parts such as trimming, bending, and hemming without removing the part from the fixture and requiring geometry specific fixture.

### 9. Deployable Robotic Systems

Some embodiments relate to deployable robotic systems with an unfolded configuration that forms a robotic part forming system (such as the robotic sheet metal part forming system described with respect to FIG. 1) and with a folded configuration that forms one or more transportable structures. For example, a structure may resemble and/or be treated as a transportable container, such as an intermodal freight shipping container. A structure may even be compliant for transportation as a container (e.g., a structure is certified as an intermodal freight shipping container).

Among other advantages, the deployable robotic system in the folded configuration can be conveniently transported to a new location, transformed (e.g., via unfolding) into the robotic part forming system, and then controlled to perform robotic part forming operations at the new location (as opposed to shipping individual components to the new location and then (e.g., manually) assembling the robotic part forming system at the new location). In some embodiments, after the part forming operations are complete, the deployable robotic system may be transformed back into the folded configuration (with the part forming components contained in the folded configuration) and conveniently moved to another location.

Furthermore, a structure of the folded configuration may have one or more physical aspects or qualities of an intermodal freight shipping container. For example, the structure is classified, certified, considered, treated, or any combination thereof as an intermodal freight shipping container (e.g., by the ISO, a shipping transport vehicle, a piece of shipping equipment, a shipping company, or any combination thereof). An intermodal freight shipping container may refer to a standardized crate designed and built for intermodal freight transport, meaning the container can be used across different modes of transport—such as from ships to trains to trucks—without unloading and reloading its cargo. Intermodal freight shipping containers come in various sizes offering versatility for different freight needs.

A structure of a deployable robotic system with physical aspects or qualities of an intermodal freight shipping container may allow the structure to be transported using the same or similar methods as intermodal freight shipping containers and/or transported with other intermodal freight shipping containers (e.g., on a container ship, train, and/or truck configured to transport one or more intermodal freight shipping containers).

Physical aspects and quantities of intermodal freight shipping containers (e.g., external dimensions and stacking strength) may be defined by a standards entity. A standards entity develops and sets standards for intermodal freight shipping containers. For example, a standards entity defines the sizes, shapes, external dimensions, maximum gross mass, and stacking strength for intermodal freight shipping containers. In another example, a standards entity defines coupling mechanisms for intermodal freight shipping containers (e.g., the sizes, shapes, dimensions, and stacking strength).

A standards entity may be an independent, non-governmental, international standard development organization. An example standards entity is the International Organization for Standardization (ISO). Standards of the ISO for intermodal freight shipping containers are specified in documents including: “ISO 668-Series 1 freight containers-Classification, dimensions and ratings” (referred to herein as “ISO 668”), “ISO 1161 Series 1 freight containers—Corner and intermediate fittings—Specifications” (referred to herein as ISO 1161), and “ISO 1496-1 Series 1 freight containers—Specification and testing” (referred to herein as “ISO 1496-1”). A structure that complies with ISO standards for intermodal freight shipping containers may be referred to as an “ISO structure.”

A structure of a deployable robotic system may satisfy one or more (e.g., all applicable) standards for intermodal freight shipping containers defined by a standards entity (e.g., the ISO). Example standards are further described below.

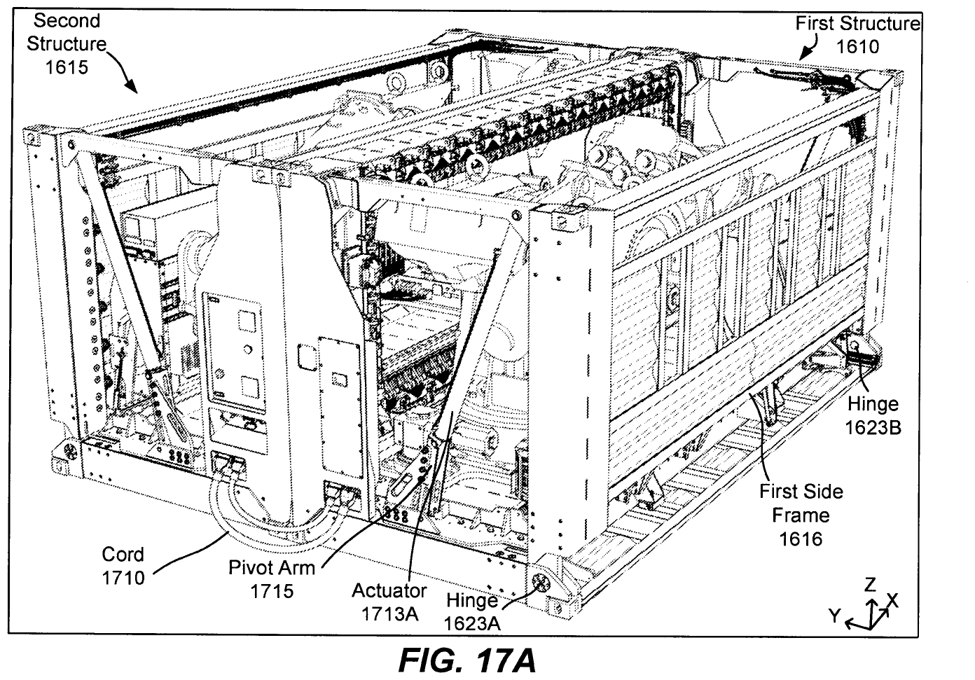

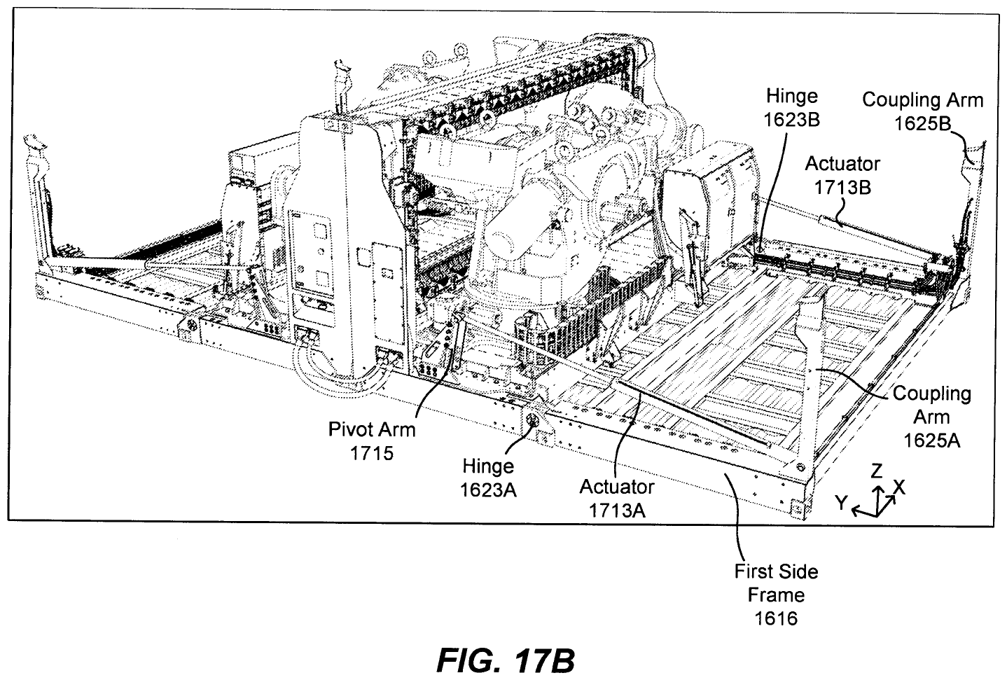

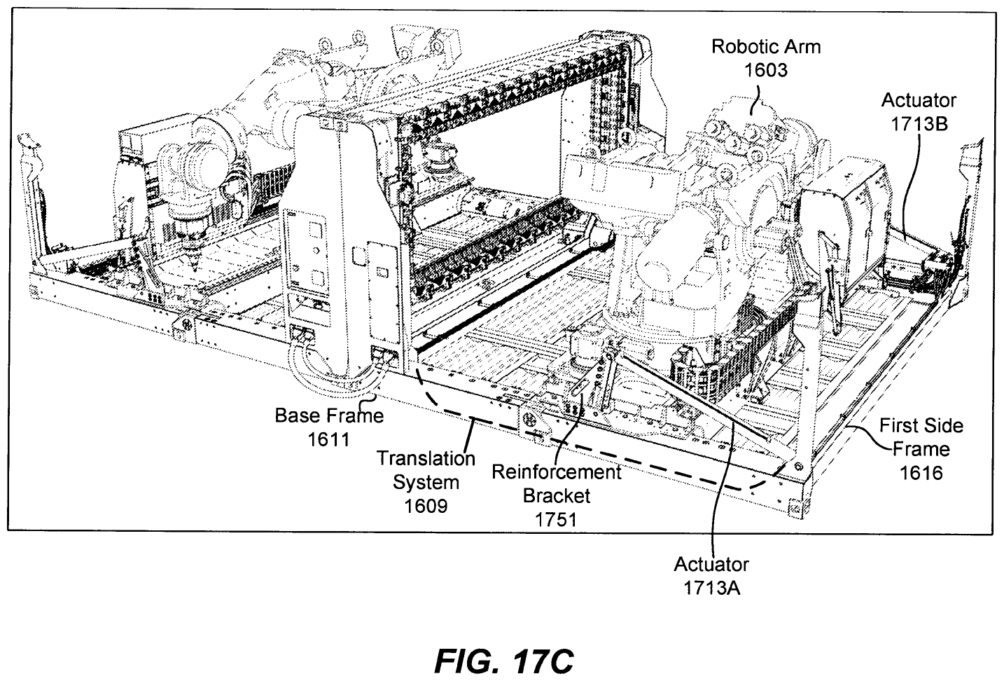

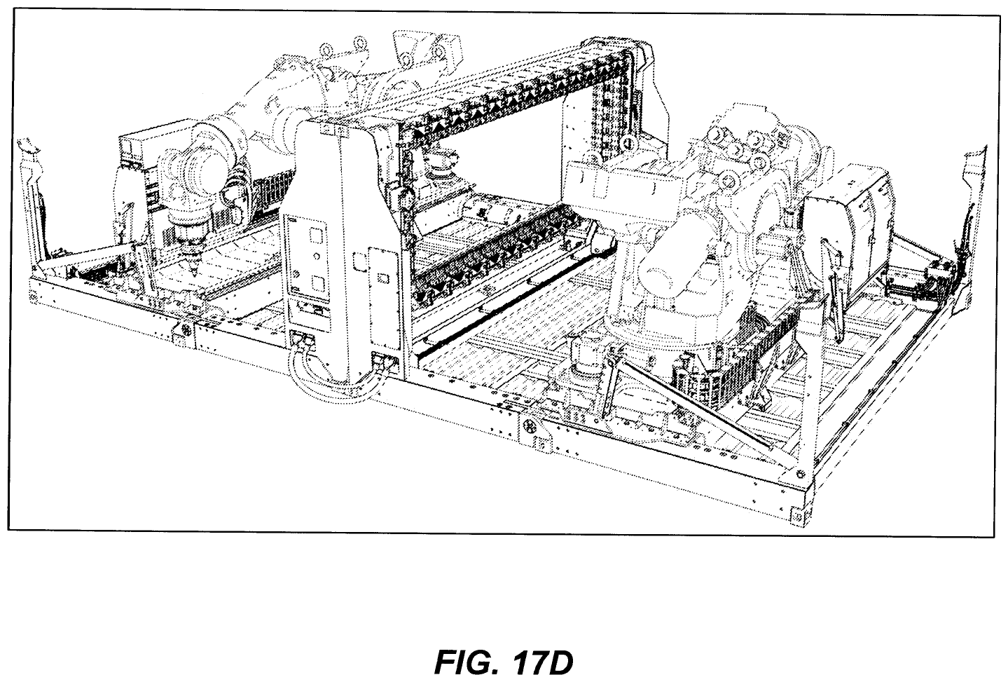

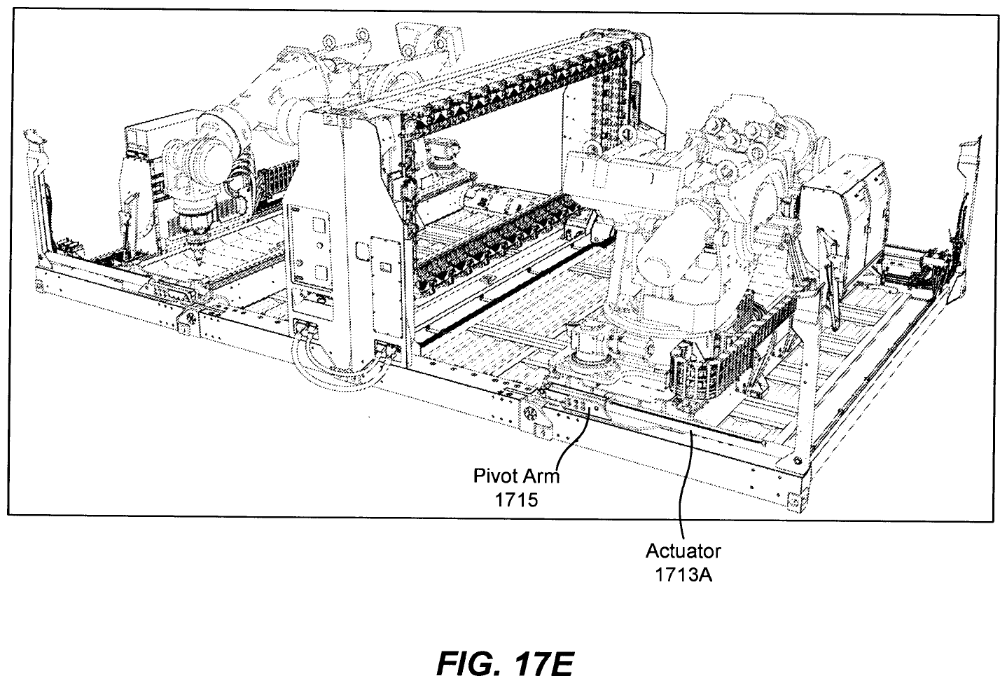

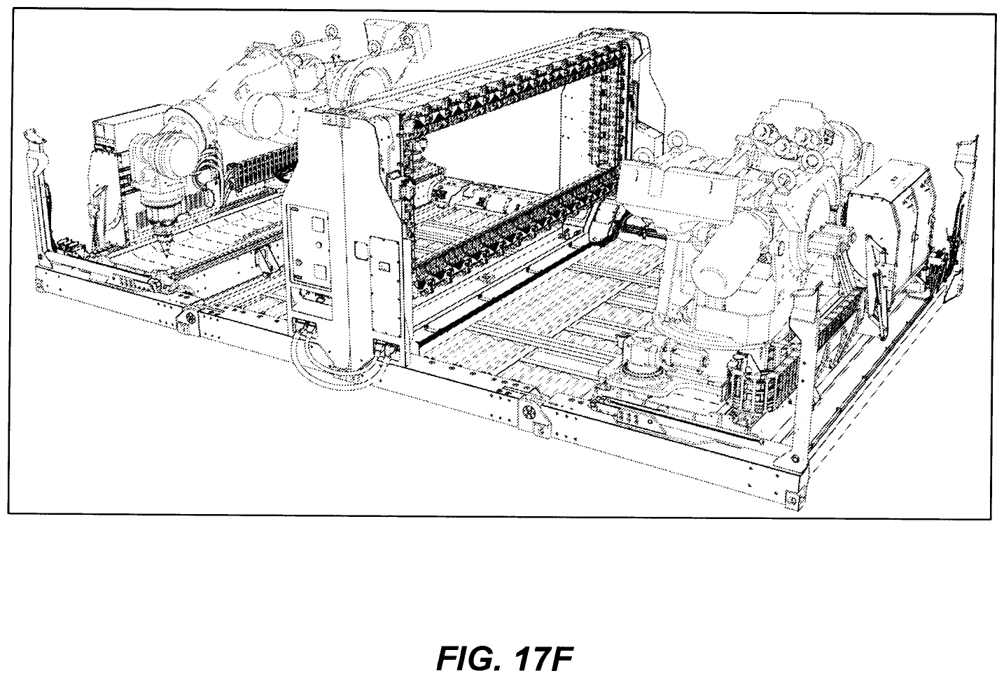

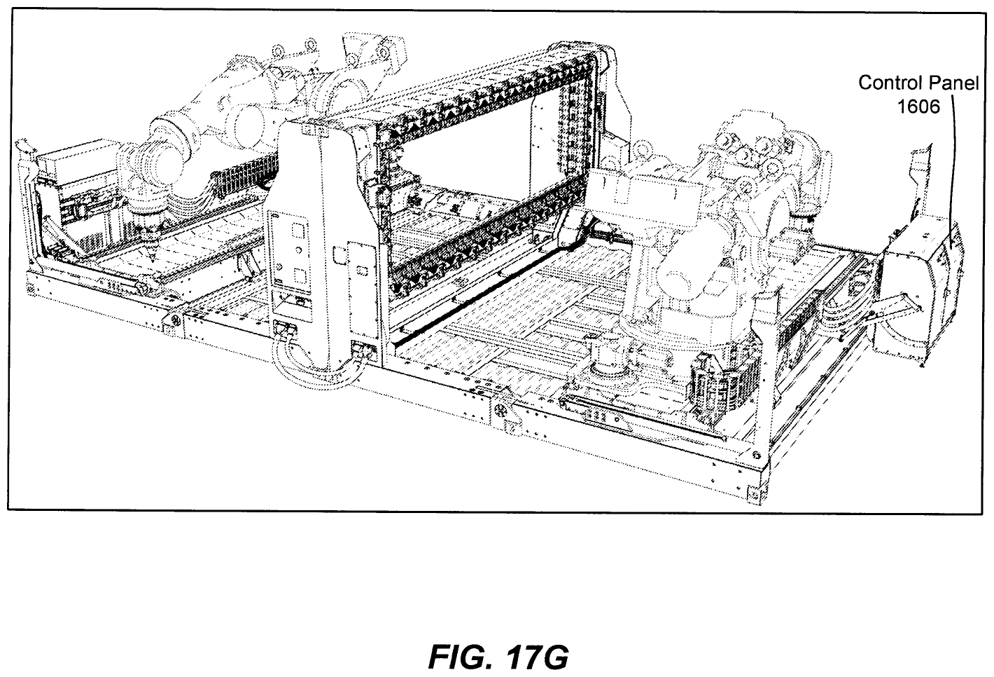

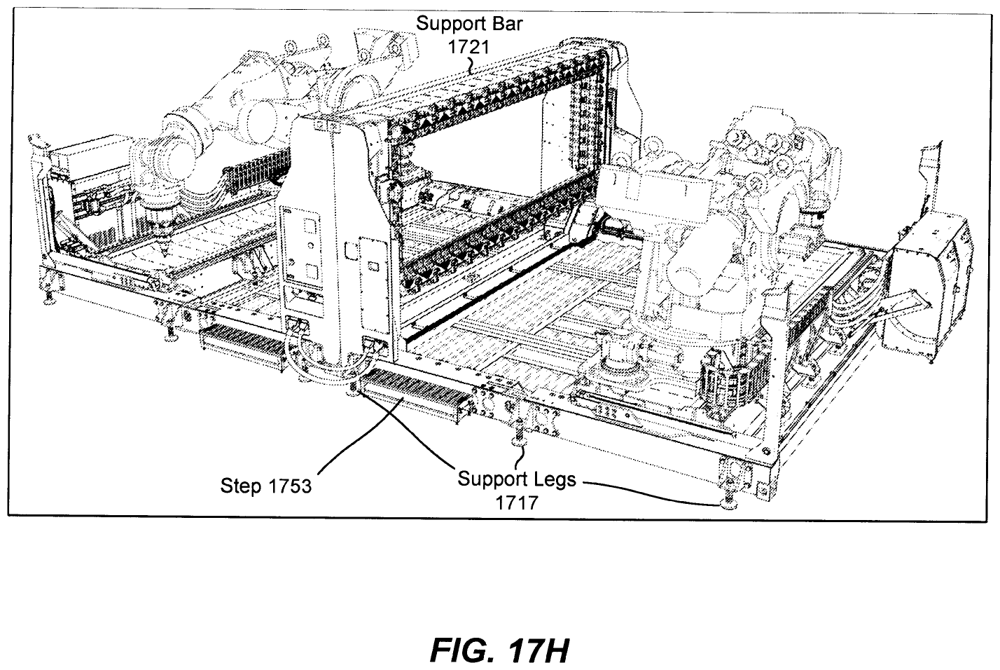

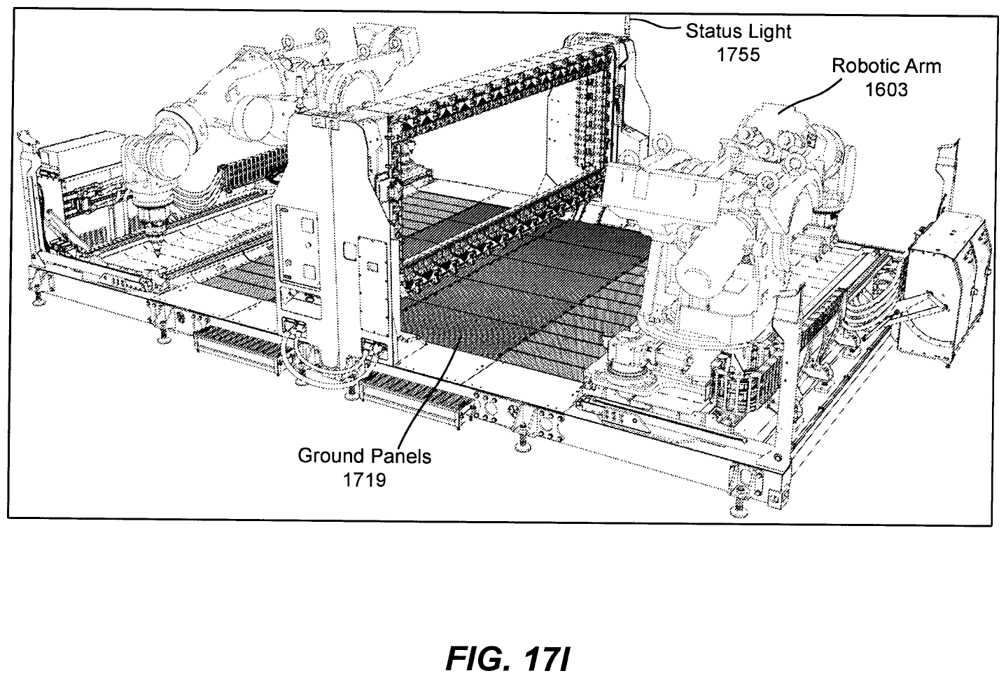

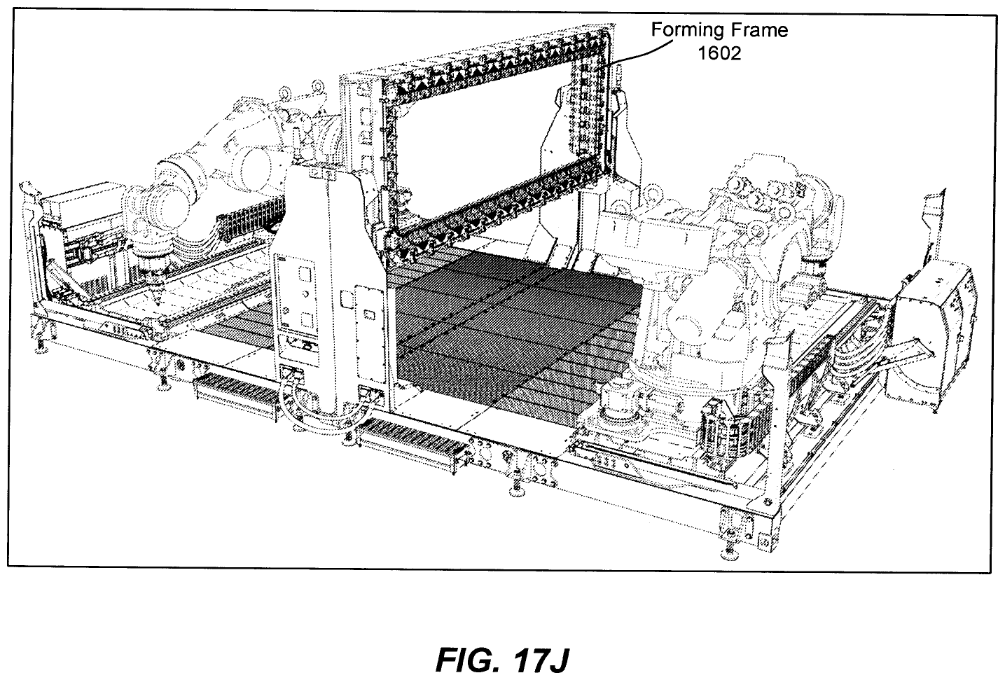

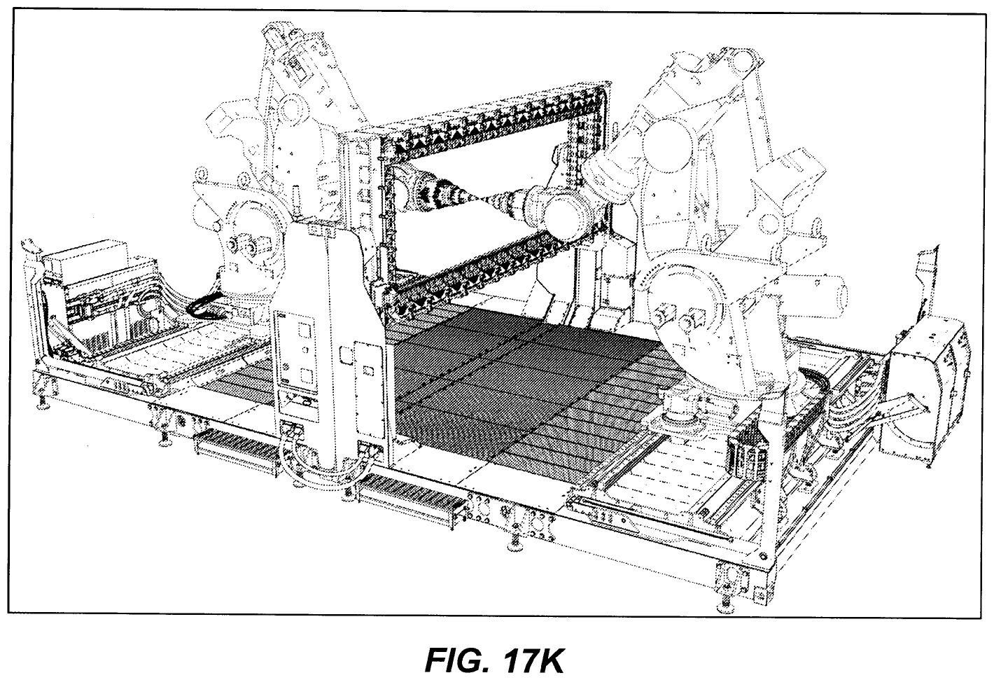

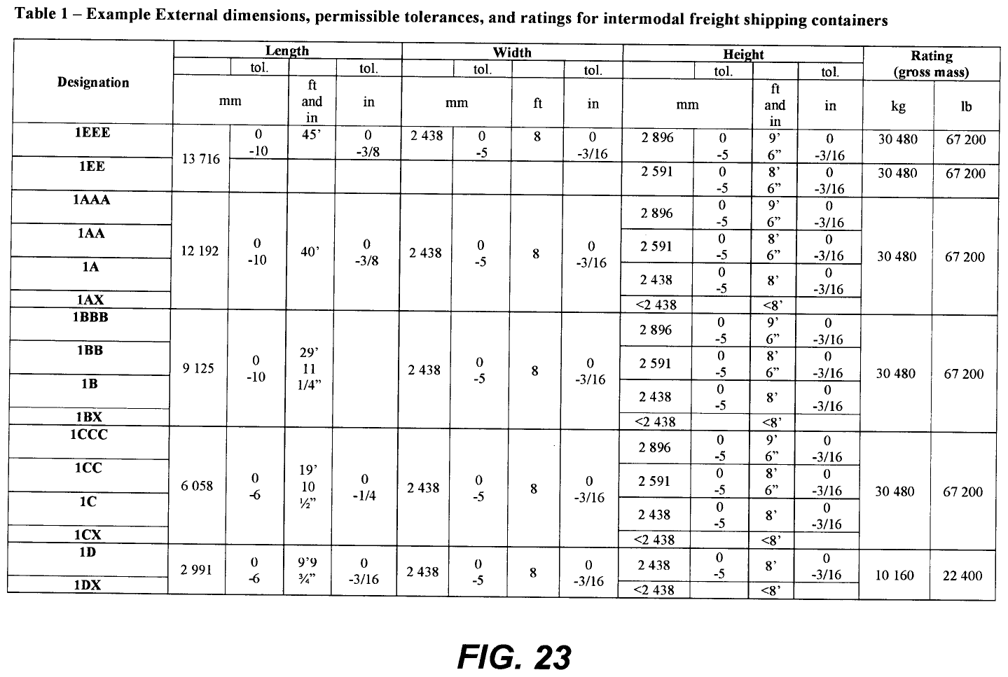

A structure includes frames that may form a rectangular prism. In some embodiments, a structure of a deployable robotic system has one or more external dimensions (e.g., a height, length, width, or any combination thereof) that satisfy one or more standards for external dimensions of intermodal freight shipping containers defined by a standards entity. For example, the structure has one or more external dimensions that satisfies one or more external dimensions defined by ISO 668. In another example, the structure has one or more external dimensions consistent with the external dimensions in Table 1 (see FIG. 23). In some embodiments, the following elements or aspects may help achieve a structure of a deployable robotic system that satisfies one or more external dimension standards: a side frame (e.g., 1616) that folds down to become part of the base of the part forming system and provides a large deployed footprint; the robotic arm (e.g., 1603) can be pushed outwards onto the side frame allowing for a larger distance from the robot arm to the forming frame (e.g., 1602); a forming frame that moves upwards to a final height to match the needs of the robot arm size (e.g., see FIGS. 17I-17K); or any combination thereof.

In some embodiments, a structure of a deployable robotic system has a gross mass (total weight) that satisfies a maximum gross mass standard of a standards entity. For example, the structure has a gross mass that satisfies a maximum gross mass standard defined by ISO 668.In another example, the structure has a gross mass less than a maximum gross mass specified in Table 1 (see FIG. 23). To satisfy a gross mass standard, a deployable robotic system (e.g., 1600) may have multiple portions (e.g., 1629 and 1631) to spread out the gross mass across multiple transportable structures. Each portion may include a single robotic arm (and the components associated with that arm). In some embodiments, the deployable robotic system has two halves that are approximately equal in weight and that each satisfy a gross mass standard.

In some embodiments, a structure of a deployable robotic system has a stacking strength that satisfies a stacking strength standard of a standards entity (stacking strength is a measure of how much weight can be placed on top of a container or structure without starting to crush). For example, a structure has a stacking strength of at least 213,360 kg (470,400 lbs.). In another example, a structure has a stacking strength that satisfies one or more stacking strength standards defined by ISO 1496-1. For a structure to satisfy a stacking strength standard, frames may be designed such that the vertical columns (in the folded configuration) have enough strength to withstand the force(s) specified by a stacking strength standard. To do this, a structure may be analyzed using FEA (finite element analysis) methods to validate that it can support the loads.

In some embodiments, a structure of a deployable robotic system includes coupling mechanisms (e.g., corner and intermediate coupling mechanisms) that satisfy coupling mechanism standards of a standards entity (e.g., the ISO). For example, a structure includes corner castings and/or intermediate castings that satisfy one or more (e.g., all applicable) standards defined by ISO 1161.

A structure of a robotic system may be classified, certified, considered, or treated (or any combination thereof) as an intermodal freight shipping container and/or may provide similar advantages of an intermodal freight shipping container even if the structure does not satisfy all standards for intermodal freight shipping containers (e.g., defined by a standards entity).

In a first example, a vehicle configured to transport intermodal freight shipping containers (e.g., a forklift or container truck) may still be able to move a structure (e.g., first structure 1610), even if the structure does not satisfy all of the standards. For example, if a structure has a length and width and has corning coupling mechanisms that satisfy the standards but does not have a height that satisfies the standards, then a container truck configured to transport intermodal freight shipping containers may still be able to transport the structure.

In a second example, a structure of a robotic system can be treated as an intermodal freight shipping container even if it does not satisfy standards that are not applicable for that structure. For example, in embodiments where a structure doesn't include a door (e.g., first structure 1610 doesn't include a door), the structure does not need to satisfy door requirements (e.g., minimum door opening sizes) of intermodal freight shipping container for the structure to be considered an intermodal freight shipping container. In another example, internal dimension requirements (e.g., minimum internal dimension requirements) for intermodal freight shipping containers may not be applicable to a structure of a deployable robotic system (e.g., since the robotic part forming components are part of the structure and already within the structure). Thus, the structure does not need to satisfy those internal dimension requirements to be considered an intermodal freight shipping container.

FIGS. 16A-16E (“FIG. 16” collectively) are diagrams of a first example deployable robotic system 1600. FIG. 16A is a perspective view diagram and FIG. 16B is a side view diagram of deployable robotic system 1600 in the unfolded configuration to form robotic part forming system 1601.

Robotic part forming system 1601 is configured to perform part forming operations as previously described. For example, robotic part forming system 1601 may have the same or similar components as the robotic systems previously described and/or may operate similar to the robotic systems previously described (e.g., described with respect to FIGS. 1-15).

Robotic part forming system 1601 includes two portions (e.g., two halves) that may be coupled together to form robotic part forming system 1601 (the portions are labeled first portion 1629 and second portion 1631). Each portion may fold into a separate structure as further described below. For convenience and ease of description, components of first portion 1629 are labeled in FIG. 16. Second portion 1631 may have the same or similar components (e.g., as illustrated).

First portion 1629 includes control panel 1606, robotic arm 1603 with base 1608, and translation system 1609. In the example of FIG. 16, first portion 1629 includes forming frame 1602 and second portion 1631 does not include a frame. However, in other embodiments, each portion may include (a) a frame or (b) portions of a frame that couple together to form a single frame.

Robotic arm 1603 on base 1608, which is coupled to translation system 1609. Robotic arm 1603 is configured to move through space (e.g., it includes an actuator system) and to perform part forming operations on an object (e.g., sheet metal 110) that is, for example, held by forming frame 1602. For example, robotic arm 1603 uses a tool (e.g., tool 125) to exert a force on an object to deform a piece of sheet metal. Robotic arm 1603 may work in conjunction with the second robotic arm (not labeled in FIG. 16), as previously described. Robotic arm 1603 may be similar to arm 120.

Translation system 1609 is configured to move base 1608 of robotic arm 1603. For example, translation system 1609 can change the distance between robotic arm 1603 and forming frame 1602 (along the y-axis) and can move robotic arm 1603 laterally (along the x-axis). Translation system 1609 may include a rail or track that base 1608 slides or rolls along and a motor and/or actuator (e.g., 1713A, 1713B) configured to move base 1608 along the rail or track. Translation system 1609 may be used to move robotic arm 1603 during the unfolding process, the folding process, during part forming operations, or any combination thereof.

Control panel 1606 is electronically coupled to robotic arm 1603. Control panel 1606 is configured to control operations of robotic arm 1603. Control panel 1606 may include user interfaces (e.g., mechanical buttons or a touch screen) that allow a user to control operations of robotic arm 1603. Control panel 1606 may control operations related to initialization of robotic arm 1603 (e.g., after deployable robotic system 1600 is unfolded), part forming operations, shutdown of robotic arm 1603 (e.g., after part forming operations are complete or prior to the folding process of deployable robotic system 1600), or any combination thereof.

Forming frame 1602 includes a clamping system configured to hold an object in place during part forming operations. For example, clamps of forming frame 1602 hold edges of a piece of sheet metal. Forming frame 1602 may be similar to forming frame 115 or 915. In the example of FIG. 16, forming frame 1602 is parallel to the length of robotic part forming system 1601.

FIG. 16C is a perspective view diagram of deployable robotic system 1600 in a folded configuration that forms two rectangular structures (labeled first structure 1610 and second structure 1615). More specifically, first structure 1610 is a folded configuration of first portion 1629 and second structure 1615 is a folded configuration of second portion 1631. In other embodiments, a folded configuration of a deployable robotic system may form a single structure or more than two structures. FIG. 16C also indicates the height, width, and length of first structure 1610.

To fold into structures, the portions of deployable robotic system 1600 include sets of frames. A frame forms one or more sides of a structure (e.g., a frame is rectangular, and/or the frames form a rectangular prism). A frame may include an open portion (e.g., a hole that allows visibility through the frame, such as second side frame 1618) or no open portions (e.g., it is a panel or wall with no holes, such as base frame 1611). A frame may be made of metal. A frame may provide structural support for the structure. Example frames are indicated in FIG. 16D, which is the same diagram as FIG. 16C, except frames of the structures are indicated via fill patterns. First structure 1610 includes base frame 1611, first side frame 1616, and second side frame 1618. First structure 1610 also includes coupling arms 1625A, 1625B (one or both coupling arms may be considered part of first side frame 1616 or second side frame 1618). As illustrated, robotic part forming components of first portion 1629 (including robotic arm 1603 and translation system 1609) may be contained within first structure 1610. A robotic part forming component may be part of or coupled to a frame of first structure 1610. For example, in FIG. 16: (a) forming frame 1602 is part of second side frame 1618, (b) a rail or track of translation system 1609 is part of base 1608 and first side frame 1616, and (c) base 1608 of robotic arm 1603 is coupled to base frame 1611 (other embodiments are not required to include all of (a)-(c)). Second structure 1615 may include similar frames and coupling arms (these are indicated using similar fill patterns but are not labeled in FIG. 16D). However, in the example of FIG. 16, second portion 1631 doesn't include a forming frame. Thus, second side frame of second structure 1615 doesn't include a forming frame.

Base frame 1611 is configured to rest on a surface of the external environment (e.g., on the ground or another structure (e.g., an intermodal freight shipping container). Second side frame 1618 is coupled to one side of base frame 1611, and first side frame 1616 is coupled to another side of base frame 1611. Thus, in the folded configuration, first side frame 1616 and second side frame 1618 form opposite sides of first structure 1610 (e.g., they are both parallel to the xz axis and base frame 1611 is parallel to the xy axis).

First side frame 1616 is coupled to base frame 1611 via coupler elements that form hinges 1623A, 1623B (note that additional or fewer hinges may be used). Hinges 1623A, 1623B allow first side frame 1616 to pivot about an axis parallel to the x-axis relative to base frame 1611 (thus the hinges form a pivot point for first side frame 1616).

Coupling arms 1625A, 1625B couple first side frame 1616 and second side frame 1618 together in the folded configuration. This forms a top portion of first structure 1610 (opposite the base frame 1611 and parallel to the xy axis).

In the example of FIG. 16, sides of first structure 1610 include open portions, which allows visibility of the robotic part forming components (which may be part of and/or within the frames). These open portions may be covered up with coverings, such as detachable panels or tarps installed at the sides (e.g., prior to transportation of first structure 1610). The coverings may helping protect the internal components during transport. If panels are used, they may reinforce the frames (e.g., to increase the maximum stacking strength of first structure 1610). Additionally, or alternatively, coverings at the sides may help first structure 1610 satisfy one or more requirements for intermodal freight shipping containers.

A structure of a robotic system may include a coupling mechanism, such as a corner coupling mechanism (at a corner of the structure) or an intermediate coupling mechanism (between corners of the structure e.g., along an edge). A coupling mechanism may enable the structure to couple to external objects or surfaces, such as intermodal freight shipping containers or surfaces configured to couple to intermodal freight shipping containers. In the example of FIG. 16, first structure 1610 includes coupling mechanisms (e.g., see FIG. 16E for magnified views of the corner coupling mechanisms) that are corner castings 1620 (e.g., that satisfy ISO standards). However, other types of corner coupling mechanisms may be used. First structure 1610 includes a coupling mechanism at each of the eight corners, however a structure may have fewer or additional coupling mechanisms. Additionally, a structure may have coupling mechanisms at different locations.

An example unfolding process of deployable robotic system 1600 is further described below with respect to FIGS. 17A-17K (“FIG. 17” collectively).

In FIG. 17A, both structures are positioned directly adjacent to each other and coupled together prior to transformation (e.g., an unfolding process). More specifically, the second side frames of each structure are physically coupled together (e.g., via bolts after manually aligning the structures). Additionally, or alternatively, the structures may be electronically, pneumatically, hydraulically, fluidly, or any combination thereof coupled together prior to the unfolding process (e.g., see cord 1710 coupled to both structures). However, placing both structures next to each other and coupling both structures together before unfolding is not required. For example, one or both structures may be unfolded before being placed next to each other or before being coupled to each other.

In the remaining figures, steps of the unfolding process are describe with respect to first structure 1610. Second structure 1615 undergoes similar steps (however this is not required).

Transitioning from FIG. 17A to 17B, first side frame 1616 is rotated downward to the ground via hinges 1623A and 1623B. First side frame 1616 may be lowered via actuators 1713A, 1713B, which are coupled to ends of translation system 1609 (along the x-axis) and ends of first side frame 1616 (e.g., where coupling arms are coupled to first side frame 1616). More specifically, pivot arms (including pivot arm 1715) couple each actuator to ends of translation system 1609. Prior to lowering, coupling arms 1625A, 1625B are decoupled from second side frame 1618 (in other embodiments, coupling arms 1625A, 1625B may additionally, or alternatively, be decoupled from first side frame 1616). This decoupling allows first side frame 1616 to rotate about the hinges.

Transitioning from FIG. 17B to 17C, actuators 1713A, 1713B pull robotic arm 1603 and control panel 1606 (via the translation system 1609) from being positioned on base 1608 to first side frame 1616. In other words, the actuators pull robotic arm 1603 away from second side frame 1618 (which includes forming frame 1602).

Transitioning from FIG. 17C to 17D, reinforcement brackets (e.g., 1751) of the pivots arms are removed to allow the pivot arms to be lowered to a parallel position (as illustrated in FIG. 17E).

Transitioning from FIG. 17D to 17E, the pivot arms (including pivot arm 1715) are lowered to the base of translation system 1609, which results in the actuators extending further.

Transitioning from FIG. 17E to 17F, actuators 1713A, 1713B pull robotic arm 1603 (via the translation system 1609) further away from second side frame 1618. The end distance away from second side frame 1618 may depend on the size and reach of robotic arm 1603.

Transitioning from FIG. 17F to 17G, control panel 1606 is moved from resting on translation system 1609 to resting on the external surface.

Transitioning from FIG. 17G to 17H, support legs (e.g., 1717) and access steps (e.g., step 1753) are installed to the outer edges of first side frame 1616 and base frame 1611. The support legs are installed to perform a leveling of the system. This may be useful if the floor is uneven. The support legs can also be anchored to the floor to provide additional stiffness to the robotic part forming system that may be useful in some applications, such as forming using think sheets where the forces can be high. The access steps allow for entry into the forming frame area.

Transitioning from FIG. 17H to 17I, ground panels 1719 are placed on portions of base frame 1611 and first side frame 1616 between robotic arm 1603 and second side frame 1618. Additionally, a top support bar 1721 from the second side frame of the second structure 1615 is removed. Additionally, a status light 1755 is coupled on top of the second side frame for visibility. The status light 1755 can provide signal lights that indicate the operational status of the machine.

Transitioning from FIGS. 17I to 17J, forming frame 1602 is raised up.

Transitioning from FIG. 17J to 17K, the robotic arms are repositioned from a stowed orientation to a ready position to perform part forming operations.

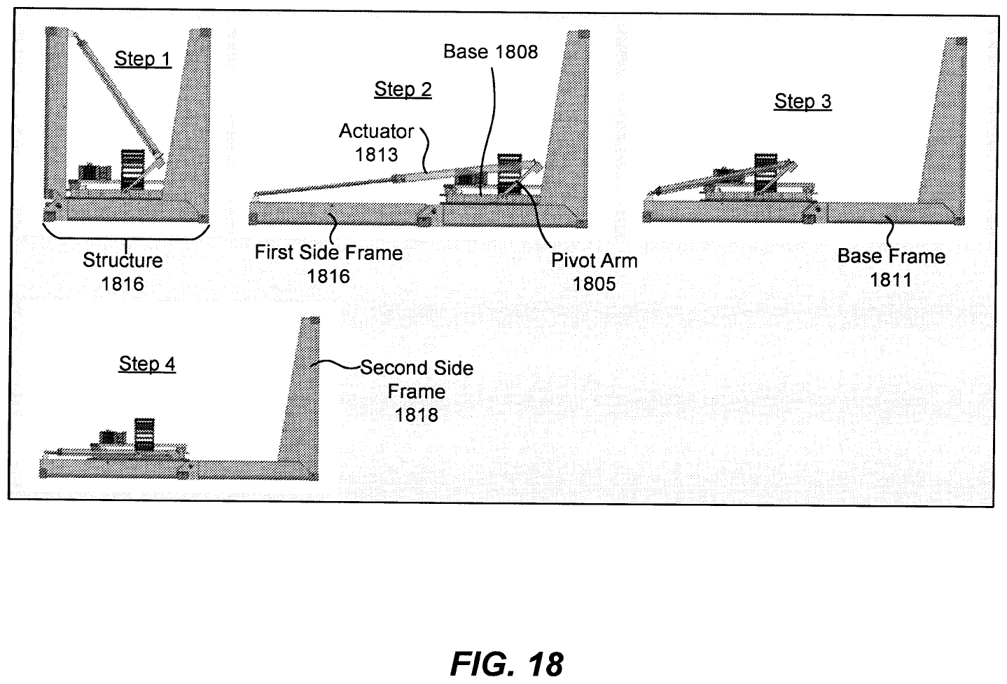

FIG. 18 is series of side view diagrams of a structure 1810 of a deployable robotic system (note that the diagrams don't include a robotic arm or control panel). Similar to FIG. 17, FIG. 18 illustrates steps performed to unfold structure 1816. At step 2, structure 1816 is lowered via actuator 1813 (similar to FIG. 17B). At step 3, actuator 1813 pulls the base 1808 away from second side frame 1818 (similar to FIG. 17C). At step 4, pivot arm 1805 is lowered (similar to FIG. 17E) and actuator 1813 pulls base 1808 farther away from second side frame 1818 (similar to FIG. 17F).

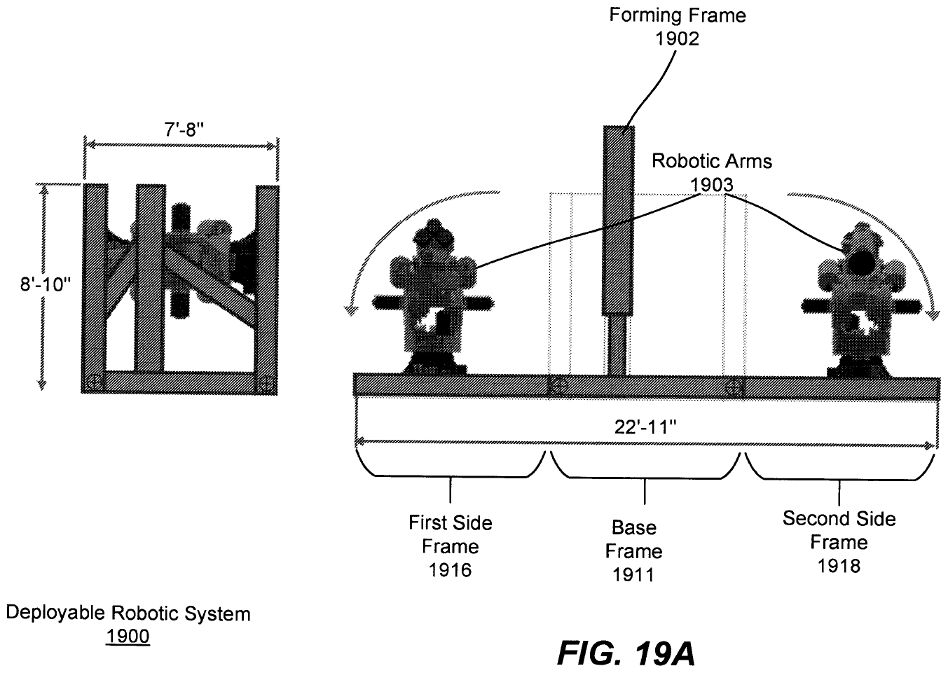

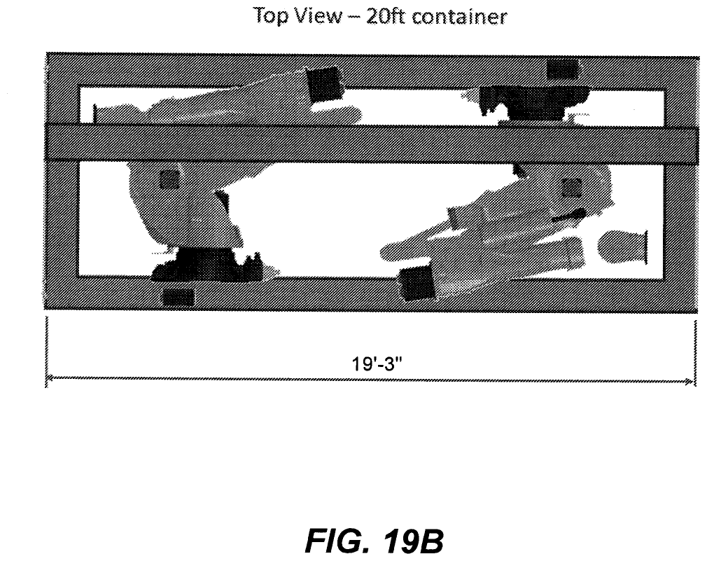

FIGS. 19A-22F are diagrams of other example deployable robotic systems.

FIGS. 19A-19B are diagrams of another example deployable robotic system 1900. FIG. 19A includes side views of a folded configuration (left diagram) and an unfolded configuration (right diagram). FIG. 19B is a top view diagram of the folded configuration. Similar to previous deployable robotic systems, deployable robotic system 1900 includes robotic arms 1903, forming frame 1902, base frame 1911, first side frame 1916, and second side frame 1918. Side frames are rotatably coupled to sides of base frame 1911. In the side and upright positions, side frames may lock into position. In this example system, the folded configuration includes both robotic arms in a single structure. Specifically, robotic arms are coupled to side frames and are held in horizontal positions in the folded configuration. Furthermore, robotic arms are positioned through forming frame 1902 in the folded configuration. Note that the dimensions indicated in FIGS. 19A-19B are just examples. Deployable robotic system 1900 may have different dimensions.

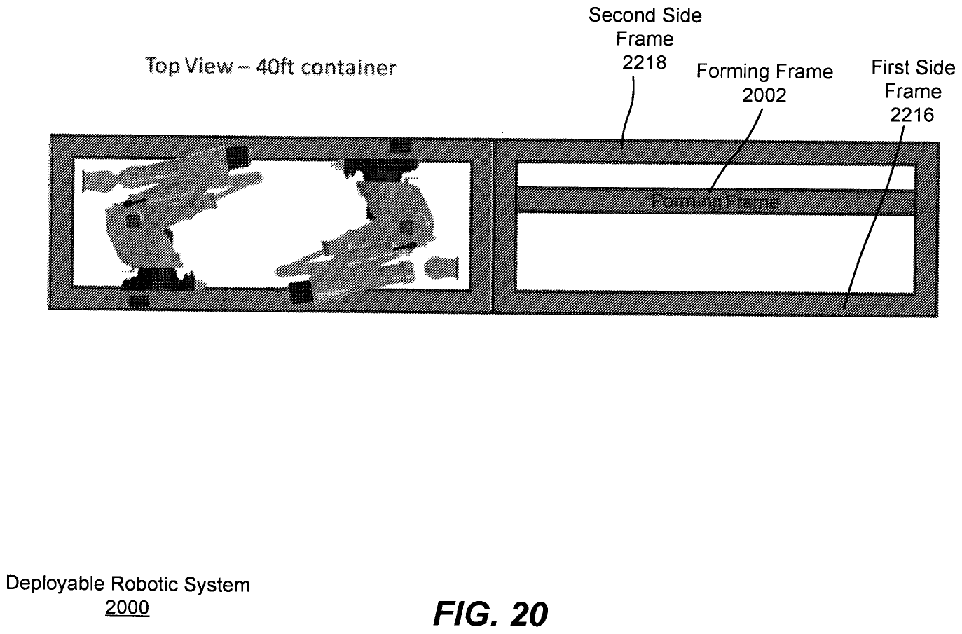

FIG. 20 is a diagram of another example deployable robotic system 2000. Specifically, FIG. 20 is a top view diagram of the folded configuration. Similar to deployable robotic system 1900, robotic arms of deployable robotic system 2000 are coupled to side frames and are held in horizontal positions in the folded configuration. However, instead of robotic arms being positioned through forming frame 2002, the arms are positioned at one end of the structure. Note that the dimensions indicated in FIG. 20 are just examples. Deployable robotic system 2000 may have different dimensions.

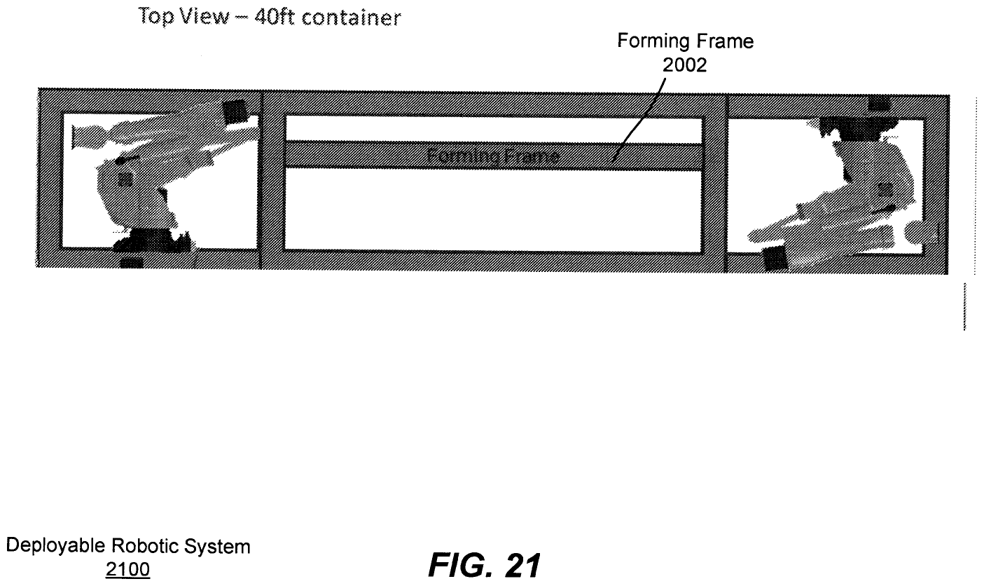

FIG. 21 is a diagram of another example deployable robotic system 2100. FIG. 21 is similar to FIG. 20, except the robotic arms are positioned at opposite ends of the structure (on either side of forming frame 2102. Note that the dimensions indicated in FIG. 21 are just examples.

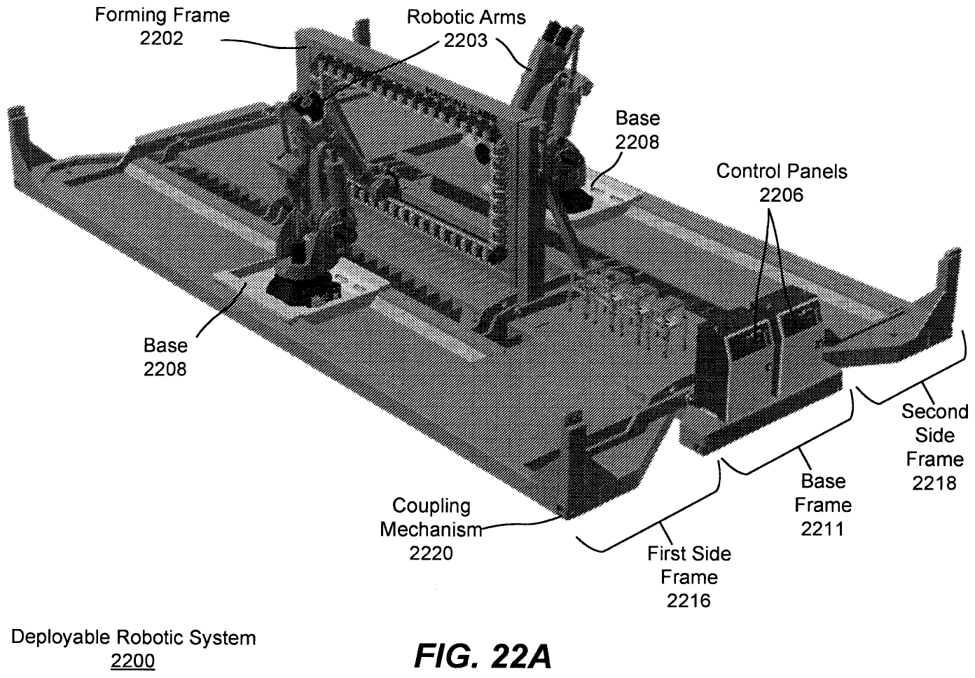

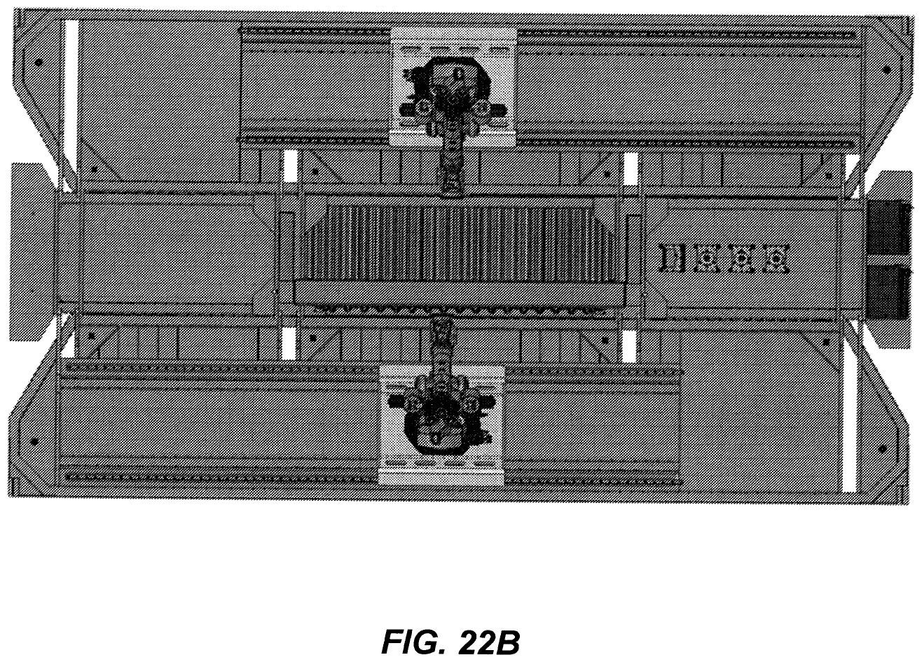

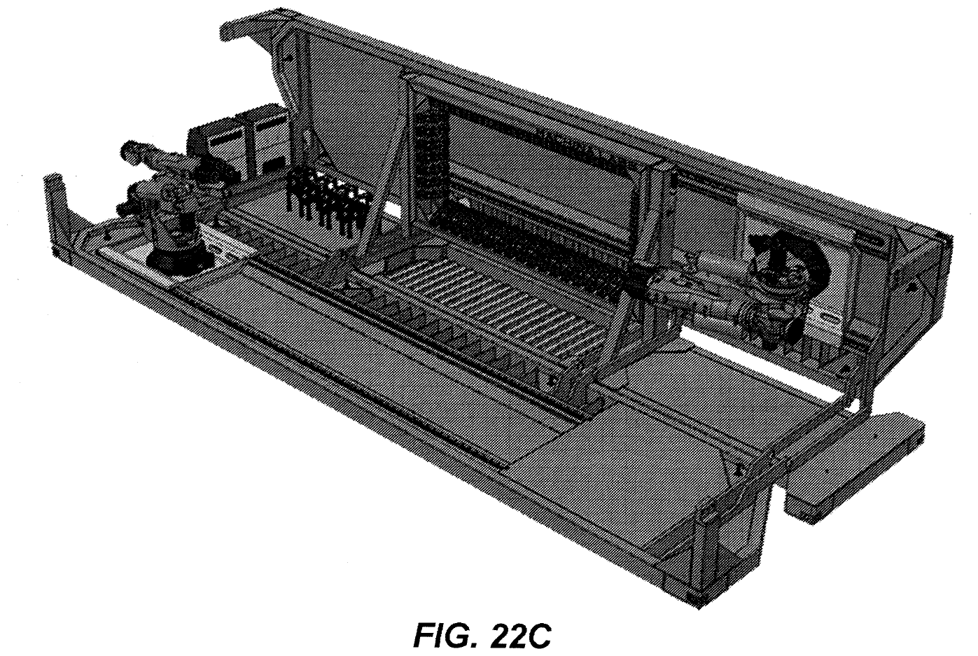

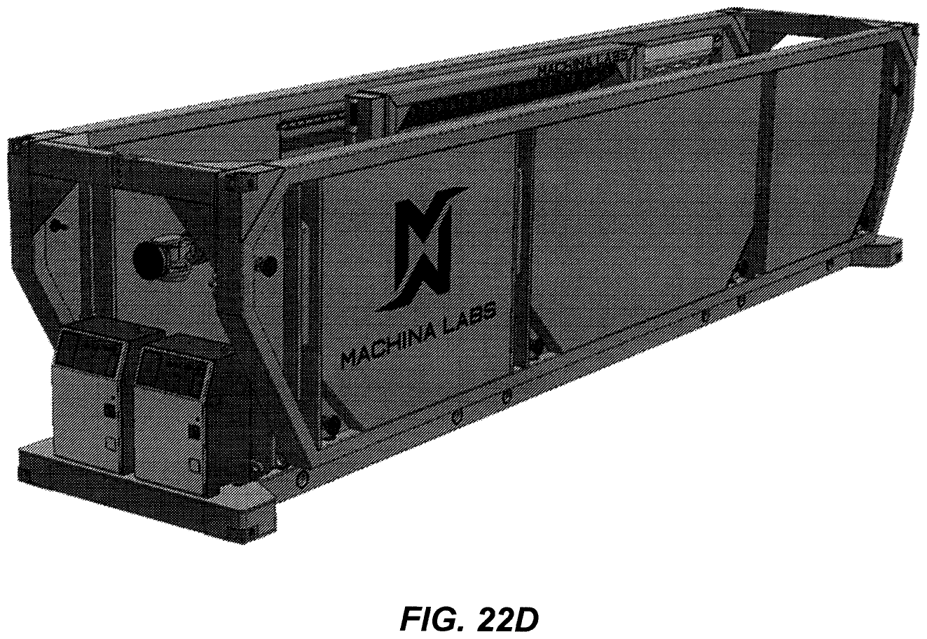

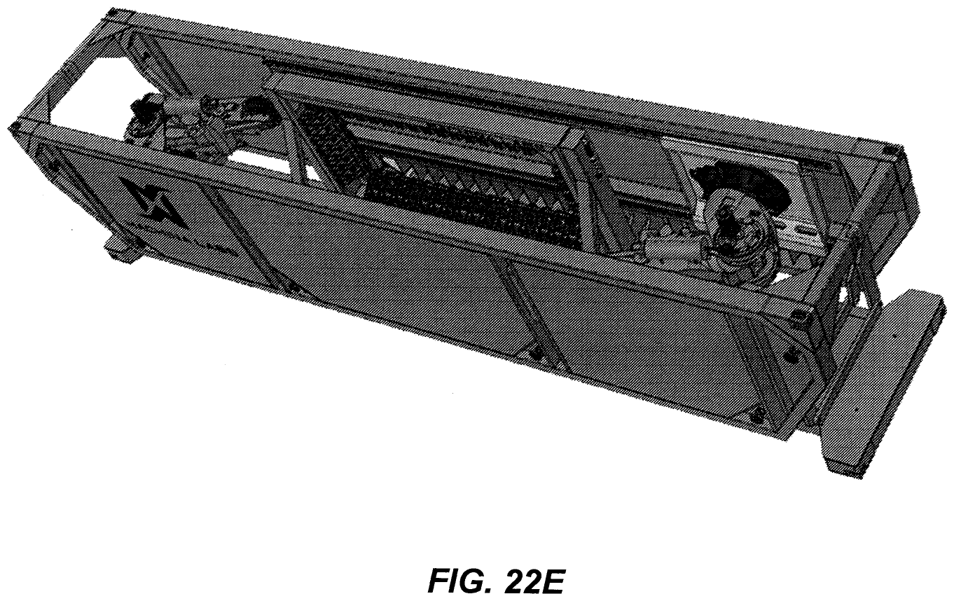

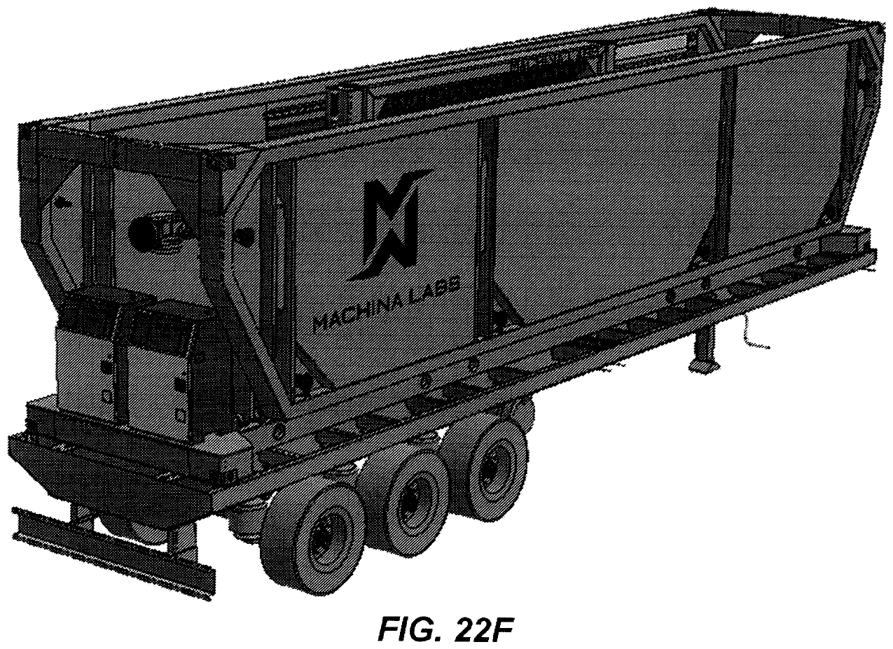

FIGS. 22A-22F are diagrams of another example deployable robotic system 2200. FIGS. 22A-B illustrate the unfolded configuration that forms a robotic part forming system, FIGS. 22D-22E illustrate the folded configuration that forms a structure, and FIG. 22F illustrates the structure on a truck trailer. Similar to previous deployable robotic systems, deployable robotic system 2200 includes robotic arms 2203, forming frame 2202, coupling mechanism (including coupling mechanism 2220), base frame 2211, first side frame 2216, and second side frame 2218. Side frames are rotatably coupled to sides of base frame 2211. In the folded configuration (e.g., FIG. 22D) coupling arms on first side frame 2216 couple to coupling arms on second side frame 2218. In this example system, the folded configuration includes both robotic arms in a single structure.

### 9.1 Additional Example Deployable Robotic Systems

Additional example embodiments of deployable robotic systems are described below. Although references are made to previous deployable robotic systems (e.g., 1600) in the below descriptions, the example embodiments described below are not required to include the components or features previously described.

Some aspects relate to a deployable robotic system (e.g., 1600, 1900, 2000, 2100, 2200) including: a set of frames (e.g., 1611, 1616, 1618) with coupler elements coupled together to form one or more pivot points (e.g., coupler elements form hinges 1623A and 1623B) (the one or more pivot points enable the frames to unfold), the set of frames configured to (a) fold into a first structure (e.g., first structure 1610) having one or more external dimensions (e.g., height, length, or width as indicated in FIG. 16C) of an intermodal freight shipping container and (b) unfold into a portion (e.g., first portion 1629) of a robotic part forming system (e.g., robotic part forming system 1601) including: a robotic arm (e.g., robotic arm 1603, 1903, 2203) with a base (e.g., base 1608) coupled to (e.g., via translation system 1609) a first frame (e.g., base frame 1611 and/or first side frame 1616) of the set of frames; and an actuator system configured to control motion of the robotic arm through space.

In some aspects, the first structure is classified, certified, considered, treated, or any combination thereof as an intermodal freight shipping container. Note that the terms “classified,” “certified,” “considered,” and “treated” are not necessarily mutually exclusive. For example, a structure that is certified as an intermodal freight shipping container may also be treated as an intermodal freight shipping container (e.g., during a transportation process).

In some aspects, the first structure is certified as an intermodal freight shipping container (e.g., by the ISO). The first structure may be certified after undergoing testing.

In some aspects, the first structure has the same height, length, and width of an intermodal freight shipping container.

In some aspects, the one or more external dimensions of the first structure satisfy standards for external dimensions of an intermodal freight shipping container defined by the International Organization for Standardization (ISO).

In some aspects, the one or more external dimensions of the first structure satisfy standards for external dimensions of an intermodal freight shipping container (e.g., defined by ISO 668).

In some aspects, the set of frames includes corner and/or intermediate coupling mechanisms (e.g., corner castings 1620) of an intermodal freight shipping container, the corner and/or intermediate coupling mechanisms configured to couple the first structure to an intermodal freight shipping container.

In some aspects, the corner and/or intermediate coupling mechanisms are corner castings of an intermodal freight shipping container.

In some aspects, the corner and/or intermediate coupling mechanisms satisfy standards for corner and/or intermediate coupling mechanisms of an intermodal freight shipping container defined by the International Organization for Standardization (ISO).

In some aspects, the corner and/or intermediate coupling mechanisms satisfy standards for corner and/or intermediate coupling mechanisms of an intermodal freight shipping container (e.g., defined in ISO 1161).

In some aspects, the first structure has a total mass that satisfies a maximum gross mass rating for an intermodal freight shipping container (e.g., defined by ISO 668).

In some aspects, the techniques described herein relate to a deployable robotic system, wherein the first structure has a stacking strength that satisfies a stacking strength standard for an intermodal freight shipping container (e.g., defined by ISO 1496-1).

In some aspects, the base of the robotic arm is mounted to a translation system (e.g., translation system 1609) coupled one of the frames, the robotic arm configured to move along the translation system.

In some aspects, the portion of the robotic forming system further includes a control panel (e.g., control panel 1606) coupled to one of the frames of the set and/or the robotic arm, the control panel including a user interface element configured to control an aspect of the robotic arm.

In some aspects, one of the frames of the set of frames includes a clamping system configured to hold a part to be formed by the robotic part forming system (e.g., second side frame 1618 includes forming frame 1602 (which includes a clamping system)).

In some aspects, the portion of the robotic forming system further includes a forming frame (e.g., forming frame 1602) with a clamping system configured to hold a part to be formed by the robotic part forming system.

In some aspects, the deployable robotic system further includes: a second set of frames (e.g., see frames of second structure 1615 in FIG. 16D) with second coupler elements coupled together to form second pivot points, the set of frames configured to (a) fold into a second structure (e.g. Second structure 1615) having one or more external dimensions of an intermodal freight shipping container and (b) unfold into a second portion of the robotic part forming system (e.g., 1601) including: a second robotic arm with a second base coupled to a first frame of the second set of frames (e.g., see FIGS. 16A-16B); the second robotic arm including a second actuator system configured to control motion of the second robotic arm through space, wherein: the second set of frames are configured to couple to the set of frames (e.g., see FIG. 17A and related description); and the robotic arm and the second robotic arm are configured to coordinate with each other during part forming operations of the robotic forming system (e.g., see FIGS. 16A-16B and 17K).

In some aspects, the set of frames includes: a base frame (e.g., base frame 1611) configured to rest on a surface of an external environment; a first side frame (e.g., first side frame 1616)) configured to rotate from an upright position downward to the surface of the external environment; an actuator (e.g., actuators 1713) configured to move the robotic arm from a location over the base frame to a location over the first side frame after the first side frame is rotated downward (e.g., see FIGS. 17B-17C); a second side frame (e.g., second side frame 1618) opposite the first side frame when the set of frames are in a folded configuration, the second side frame configured to remain in an upright position.

In some aspects, in a folded configuration of the set of frames, the portion of the robotic part forming system is within the first structure (e.g., see FIG. 16C).

In some aspects, the portion of the robotic part forming system further includes: a second robotic arm with a second base coupled to a second frame of the set of frames; a second actuator system configured to control motion of the second robotic arm through space; and a forming frame with a clamping system configured to hold a part to be formed by the robotic part forming system. E.g., see FIGS. 19A-22F.

In some aspects, the techniques described herein relate to a deployable robotic system, wherein the base of the robotic arm is coupled to a first side frame of the set of frames and the second base of the second robotic are is coupled to a second side frame opposite the first side frame when the set of frames are in a folded configuration. E.g., see FIGS. 19A-22F.

In some aspects, the techniques described herein relate to a deployable robotic system, wherein the forming frame is coupled to a base frame configured to rest on a surface of an external environment (e.g., see FIG. 16).

In some aspects the first structure and the second structure are both certified as intermodal freight shipping containers.

Other aspects include components, devices, systems, improvements, methods, processes, applications, computer readable mediums, and other technologies related to any of the above.

### 10. Example Machine Architecture

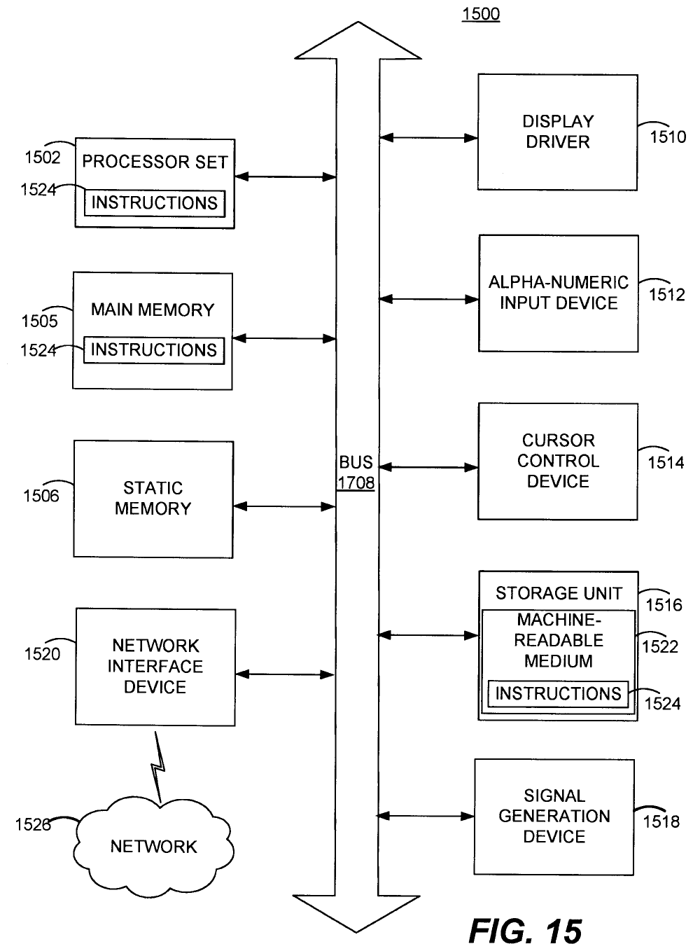

In some embodiments, the controller (e.g., controller 255 or controller 1120) is a machine able to read instructions from a machine-readable medium and execute them in a set of one or more processors. FIG. 15 is a block diagram illustrating components of an example machine able to read instructions from a machine-readable medium and execute them in a set of one or more processors. Specifically, FIG. 15 shows a diagrammatic representation of a machine in the example form of a computer system 1500. The computer system 1500 can be used to execute instructions 1524 (e.g., program code or software) for causing the machine to perform any one or more of the methodologies (or processes) described herein. In alternative embodiments, the machine operates as a standalone device or a coupled (e.g., networked) device that connects to other machines. In a networked deployment, the machine may operate in the capacity of a server machine or a client machine in a server-client network environment, or as a peer machine in a peer-to-peer (or distributed) network environment. Here, the robots, e.g., 400A, 400B, and other automated components may include all or a portion of the component of the described computer system (or machine) 1500. The robots, e.g.,400A, 400B, and/or other automated components may be programmed with program code to operate as described e.g., with respect to FIGS. 1-14B. Such operation also include program code corresponding to the disclosed models, e.g., 1400, 1415, for effecting the resulting geometries through the robots, e.g., 400A, 400B and other automated components.

The machine may be a server computer, a client computer, a personal computer (PC), a tablet PC, a smartphone, an internet of things (IoT) appliance, a network router, or any machine capable of executing instructions 1524 (sequential or otherwise) that specify actions to be taken by that machine. Further, while only a single machine is illustrated, the term “machine” shall also be taken to include any collection of machines that individually or jointly execute instructions 1524 to perform any one or more of the methodologies discussed herein.

The example computer system 1500 includes a set of one or more processing units 1502. The processor set 1502 is, for example, one or more central processing units (CPUs), one or more graphics processing units (GPUs), one or more digital signal processors (DSPs), one or more state machines, one or more application specific integrated circuits (ASICs), one or more radio-frequency integrated circuits (RFICs), or any combination of these. If the processor set 1502 include multiple processors, the processors may operate individually or collectively. The processor set 1502 also may be a controller. The controller may include a non-transitory computer readable storage medium that may store program code to operate (or control) the robots, e.g.,400A, 400B, and/or other automated components described herein.

For convenience, the processor 1502 is referred to as a single entity but it should be understood that the corresponding functionality may be distributed among multiple processors using various ways, including using multi-core processors, assigning certain operations to specialized processors (e.g., graphics processing units), and dividing operations across a distributed computing environment. Any reference to a processor 1502 should be construed to include such architectures.

The computer system 1500 also includes a main memory 1504. The computer system may include a storage unit 1516. The processor 1502, memory 1504 and the storage unit 1516 communicate via a bus 1508.

In addition, the computer system 1500 can include a static memory 1506, a display driver 1510 (e.g., to drive a plasma display panel (PDP), a liquid crystal display (LCD), or a projector). The computer system 1500 may also include alphanumeric input device 1512 (e.g., a keyboard), a cursor control device 1514 (e.g., a mouse, a trackball, a joystick, a motion sensor, or other pointing instrument), a signal generation device 1518 (e.g., a speaker), and a network interface device 1520, which also are configured to communicate via the bus 1508.

The storage unit 1516 includes a machine-readable medium 1522 on which is stored instructions 1524 (e.g., software) embodying any one or more of the methodologies or functions described herein. The instructions 1524 may also reside, completely or at least partially, within the main memory 1504 or within the processor 1502 (e.g., within a processor's cache memory) during execution thereof by the computer system 1500, the main memory 1504 and the processor 1502 also constituting machine-readable media. The instructions 1524 may be transmitted or received over a network 1526 via the network interface device 1520.

While machine-readable medium 1522 is shown in an example embodiment to be a single medium, the term “machine-readable medium” should be taken to include a single medium or multiple media (e.g., a centralized or distributed database, or associated caches and servers) able to store the instructions 1524. The term “machine-readable medium” shall also be taken to include any medium that is capable of storing instructions 1524 for execution by the machine and that cause the machine to perform any one or more of the methodologies disclosed herein. The term “machine-readable medium” includes, but not be limited to, data repositories in the form of solid-state memories, optical media, and magnetic media.

While machine-readable medium 722 (also referred to as a computer-readable storage medium) is shown in an embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” shall also be taken to be a non-transitory machine-readable medium. The term “machine-readable medium” includes, but not be limited to, data repositories in the form of solid-state memories, optical media, and magnetic media.

### 11. Additional Considerations

Embodiments of the systems and/or methods can include every combination and permutation of the various system components and the various method processes.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. In some cases, a module can be implemented in hardware, firmware, or software.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done merely for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by any claims that issue.

What is claimed is:

1. A deployable robotic system comprising:
a set of frames with coupler elements coupled together to form one or more pivot points, the set of frames configured to (a) fold into a first structure having one or more external dimensions of an intermodal freight shipping structure and (b) unfold into a part of a robotic part forming system comprising:
a robotic arm with a base coupled to a first frame of the set of frames, the robotic arm including an actuator system configured to control motion of the robotic arm through space.

2. The deployable robotic system of claim 1, wherein the first structure has the same height, length, and width of an intermodal freight shipping container.

3. The deployable robotic system of claim 1, wherein the one or more external dimensions of the first structure satisfy standards for external dimensions of an intermodal freight shipping container defined by the International Organization for Standardization (ISO).

4. The deployable robotic system of claim 1, wherein the set of frames includes corner coupling mechanisms of an intermodal freight shipping container, the corner coupling mechanisms configured to couple the first structure to an intermodal freight shipping container.

5. The deployable robotic system of claim 4, wherein the corner coupling mechanisms are corner castings of an intermodal freight shipping container.

6. The deployable robotic system of claim 4, wherein the corner coupling mechanisms satisfy standards for corner coupling mechanisms of an intermodal freight shipping container.

7. The deployable robotic system of claim 1, wherein the first structure is certified as an intermodal freight shipping container.

8. The deployable robotic system of claim 1, wherein the first structure has a total mass that satisfies a maximum gross mass rating for an intermodal freight shipping container.

9. The deployable robotic system of claim 1, wherein the first structure has a stacking strength that satisfies a stacking strength standard for an intermodal freight shipping container.

10. The deployable robotic system of claim 1, wherein the base of the robotic arm is mounted to a translation system coupled one of the frames, the robotic arm configured to move along the translation system.

11. The deployable robotic system of claim 1, wherein the part of the robotic forming system further comprises a control panel coupled to the robotic arm, the control panel comprising a user interface element configured to control an aspect of the robotic arm.

12. The deployable robotic system of claim 1, wherein one of the frames of the set of frames comprises a clamping system configured to hold a part to be formed by the robotic part forming system.

13. The deployable robotic system of claim 1, wherein the part of the robotic forming system further comprises a forming frame with a clamping system configured to hold a part to be formed by the robotic part forming system.

14. The deployable robotic system of claim 1, further comprising:
a second set of frames with second coupler elements coupled together to form one or more second pivot points, the set of frames configured to (a) fold into a second structure having one or more external dimensions of an intermodal freight shipping container and (b) unfold into a second part of the robotic part forming system comprising:
a second robotic arm with a second base coupled to a first frame of the second set of frames, the second robotic arm including a second actuator system configured to control motion of the second robotic arm through space,
wherein:
the second set of frames are configured to couple to the set of frames; and
the robotic arm and the second robotic arm are configured to coordinate with each other during part forming operations of the robotic forming system.

15. The deployable robotic system of claim 1, wherein the set of frames comprises:
a base frame configured to rest on a surface of an external environment;
a first side frame configured to rotate from an upright position downward to the surface of the external environment;
an actuator configured to move the robotic arm from a location over the base frame to a location over the first side frame after the first side frame is rotated downward;
a second side frame opposite the first side frame when the set of frames are in a folded configuration, the second side frame configured to remain in an upright position.

16. The deployable robotic system of claim 1, wherein, in a folded configuration of the set of frames, the part of the robotic part forming system is within the first structure.

17. The deployable robotic system of claim 1, wherein the part of the robotic part forming system further comprises:
a second robotic arm with a second base coupled to a second frame of the set of frames, the second robotic arm including a second actuator system configured to control motion of the second robotic arm through space; and
a forming frame with a clamping system configured to hold a part to be formed by the robotic part forming system.

18. The deployable robotic system of claim 17, wherein the base of the robotic arm is coupled to a first side frame of the set of frames and the second base of the second robotic are is coupled to a second side frame opposite the first side frame when the set of frames are in a folded configuration.

19. The deployable robotic system of claim 17, wherein the forming frame is coupled to a base frame configured to rest on a surface of an external environment.

20. The deployable robotic system of claim 17, wherein the first structure and the second structure are both certified as intermodal freight shipping containers.
